(19) United States
(12) Patent Application Publication
(10) Pub. No.: US 2026/0284588 A1
(43) Pub. Date: Sep. 24, 2026

(54) CARBON DIOXIDE CAPTURE USING REDOX-ACTIVE SPECIES AND RELATED SYSTEMS AND METHODS

(71) Applicant: Massachusetts Institute of Technology, Cambridge, MA (US)

(72) Inventors: T. Alan Hatton, Sudbury, MA (US); Hyowon Seo, Cambridge, MA (US)

(73) Assignee: Massachusetts Institute of Technology, Cambridge, MA (US)

(21) Appl. No.: 19/561,924

(22) Filed: Mar. 10, 2026

Related U.S. Application Data
(60) Provisional application No. 63/769,696, filed on Mar. 10, 2025.

(51) Int. Cl. B01D 53/32

(52) U.S. Cl. CPC B01D 53/326; B01D 2257/504

(57) ABSTRACT

Carbon dioxide capture using redox-active species and related systems and methods are generally described.

### RELATED APPLICATIONS

This application claims priority under 35 U.S.C. § 119(e) to U.S. Provisional Patent Application No. 63/769,696, filed Mar. 10, 2025, and entitled “Leveraging Electrons for Electrochemical CO₂ Capture using a Hemi-Labile Iron Complex,” which is incorporated herein by reference in its entirety for all purposes.

### GOVERNMENT SPONSORSHIP

This invention was made with government support under DE-AC05-76RL01830 awarded by the U.S. Department of Energy. The government has certain rights in the invention.

### TECHNICAL FIELD

Carbon dioxide capture using redox-active species and related systems and methods are generally described.

### SUMMARY

Carbon dioxide capture using redox-active species and related systems and methods are generally described. The subject matter of the present disclosure involves, in some cases, interrelated products, alternative solutions to a particular problem, and/or a plurality of different uses of one or more systems and/or articles. This Summary introduces a selection of concepts in simplified form that are described further below in the Detailed Description. This Summary neither identifies key or essential features, nor limits the scope of, the claimed subject matter.

Certain aspects are related to methods of capturing carbon dioxide. In some embodiments, the method comprises exposing a redox-active species to carbon dioxide such that the redox-active species captures carbon dioxide, wherein the redox-active species is capable of capturing more than one molecule of carbon dioxide per electron transferred to the redox-active species. In some such embodiments, more than one molecule of carbon dioxide is captured by the redox-active species per electron transferred to the redox-active species.

In certain embodiments, the method comprises exposing a redox-active species to carbon dioxide such that the redox-active species captures carbon dioxide, wherein the method has an electron utilization of greater than 1.

Some aspects are related to carbon-capture systems. In some embodiments, the system comprises an electrochemical cell, and a redox-active species configured to capture carbon dioxide when an electrical potential is applied to the electrochemical cell, wherein the redox-active species is capable of capturing more than one molecule of carbon dioxide per electron that is transferred to the redox-active species.

In some embodiments, the carbon-capture system comprises an electrochemical cell, and a redox-active species configured to capture carbon dioxide when an electrical potential is applied to the electrochemical cell, wherein the carbon-capture system is capable of achieving an electron utilization of greater than 1.

One aspect of the disclosure herein is a carbon-capture process comprising a symmetric cyclic electrochemical system, wherein the system comprises a redox-active species comprising a ligand with multiple hemi-labile iron coordination sites. In some embodiments, the redox-active species is a metal complex. In some embodiments, the redox-active species is an organometallic species.

In one embodiment of the disclosed carbon-capture process, CO₂ reduction is prevented by the introduction of pyridine-3-carboxylic acid amide (nicotinamide) as an iron center guardian of the iron(2+) center.

In one embodiment of the disclosed carbon-capture process, the redox-active species comprises ferric ethylenediamine-di-(o-hydroxyphenylacetate) (Fe-EDDHA or equivalently FeEDDHA) in an aqueous solution with potassium nitrate (KNO₃) as an electrolyte.

In one embodiment of the disclosed carbon-capture process, the Fe-EDDHA is at a 50 mmol concentration and 1 M KNO₃.

In one embodiment of the disclosed carbon-capture process, the reaction comprises 1 M nicotinamide.

In one embodiment of the disclosed carbon-capture process, a 15% CO₂ gas stream is introduced.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control. The following Detailed Description references the accompanying drawings which form a part of this application, and which show, by way of illustration, specific example implementations. Other implementations may be made without departing from the scope of the disclosure.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 is a schematic illustration of a carbon capture and release method, in accordance with certain embodiments.

FIG. 2 is, in accordance with certain embodiments, a schematic illustration of an electrochemical system for the capture and release of carbon dioxide.

FIGS. 3A-3B show, according to certain embodiments, an electron-leveraging strategy for electrochemical carbon capture using a hemi-labile iron complex. FIG. 3A is a schematic overview of an electron-leveraging strategy using hemi-labile compounds (coordination complexes), depicting the general interaction between the ligand and CO₂, according to certain embodiments (M: metal center, L: ligand). FIG. 3B shows an electrochemical working scheme illustrating a carbon-capture process employing Fe-EDDHA as a hemi-labile redox-active coordination complex in water in the presence of nicotinamide as an iron center guardian. The detailed mechanism in FIG. 3B highlights the important role of proton transfer at the —O—Fe and —OH sites in facilitating the pH-swing mediated carbon capture.

FIGS. 4A-4D show cyclic voltammetry of Fe-EDDHA in aqueous solutions, in accordance with certain embodiments. FIG. 4A shows the cyclic voltammograms of 2 mM Fe-EDDHA under nitrogen (pH 8.0) and CO₂ (pH 8.0) in water with 1 M nicotinamide (NA) as an iron center guardian and 0.1 M KNO₃ as a supporting electrolyte, in accordance with certain embodiments. FIG. 4B shows the cyclic voltammograms of 2 mM Fe-EDDHA under nitrogen with NA (pH 8.0) and without NA (pH 8.0) in water with 0.1 M KNO₃ as a supporting electrolyte, in accordance with certain embodiments. FIG. 4C shows cyclic voltammograms of 2 mM Fe-EDDHA at pH 4, 5, 6, and 7-12 (darker for pH 7 to lighter for pH 12) in 1 M NA and 0.1 M KNO₃ solutions under N₂, in accordance with certain embodiments. pH was adjusted by addition of potassium hydroxide before the experiments. FIG. 4D shows 100 cyclic voltammograms of Fe-EDDHA, in accordance with certain embodiments. All CV curves were recorded at room temperature at a scan rate of 100 mV/s with a glassy carbon working electrode (3 mm diameter) and Pt counter electrode. Potentials were recorded versus Ag/AgCl as a reference electrode. All pH was adjusted after the introduction of CO₂ by adding 0.1 M potassium hydroxide solution or 0.1 M hydrochloric acid.

FIGS. 5A-5B show electrochemical studies of a Fe-EDDHA system in an H-cell and stability under CO₂. In particular, electrochemical pH-swing of Fe-EDDHA in an H-cell is shown. FIG. 5A is a schematic representation of the experimental setup for CO₂ capture and release using Fe-EDDHA, in accordance with certain embodiments. A 50 mM Fe-EDDHA solution in the electrochemical H-cell was reduced and oxidized electrochemically under a constant current mode at room temperature. The feed gas of 15% CO₂ was supplied through a mass-flow controller (MFC). The solution pH was monitored by a pH probe. FIG. 5B shows a pH profile of a 50 mM Fe-EDDHA solution in water with 1 M NA and 1 M KNO₃, in accordance with certain embodiments. Reduction under a constant current (−10 mA) for 22.5 min, 15% CO₂ contact at a flow rate of 30 mL/min for 20 min, followed by oxidation by a constant current (10 mA) for 22.5 min, and nitrogen purging for 10 min.

FIG. 6 shows UV-vis spectra for a CO₂ sensitivity test, in accordance with certain embodiments. The Fe(II)-EDDHA solutions in the presence of 1 M NA (curve “(a)”, 50 mM, 4 mL) were bubbled with 15% CO₂ for 20 min at a flow rate of 10 mL/min (curve “(b)”), and 100% CO₂ for 20 min at a flow rate of 10 mL/min (curve “(c)”). Curve “(d)” represents the UV-vis spectrum for Fe(III)EDDHA.

FIGS. 7A-7D show, in accordance with certain embodiments, NMR studies of the stability of the Fe-EDDHA system under CO₂. FIG. 7A shows, in accordance with certain embodiments, ¹H NMR spectra of the 50 mM Fe-EDDHA in 1 M KNO₃ aqueous solutions in the absence of NA: Fe(III)EDDHA, Fe(II)EDDHA (after electrochemical reduction) and Fe(II)EDDHA with 100% CO₂. A zoom-in of the spectra between −4-32 ppm is displayed at the bottom. FIG. 7B shows, in accordance with certain embodiments, ¹H NMR spectra of the 50 mM Fe-EDDHA in 1 M KNO₃ aqueous solutions in the presence of 1 M NA: NA (top curve), Fe(III)-EDDHA+1 M NA (next curve down), Fe(II)-EDDHA+1 M NA (next curve down), Fe(II)-EDDHA+1 M NA with 100% CO₂ (bottom curve). A zoom-in of the spectra between 3-12 ppm is displayed at the bottom. FIG. 7C shows, in accordance with certain embodiments, ¹³C NMR spectra of 1 M NA, Fe(III)-EDDHA+1 M NA, Fe(II)-EDDHA+1 M NA, and Fe(II)-EDDHA+1 M NA bubbled with 100% ¹³C-enriched CO₂ for 5 min at 25° C. FIG. 7D shows, in accordance with certain embodiments, ¹³C NMR spectra of Fe(II)-EDDHA+1 M NA+100% ¹³C-enriched CO₂ at varying temperatures.

FIGS. 8A-8E show cyclic operation of CO₂ capture and release using the Fe-EDDHA redox system. FIG. 8A shows a scheme of cyclic flow electrochemical cell using 6 mL of 50 mM Fe-EDDHA in 1 M NA and 1 M KNO₃ in water for a CO₂ capture and release experiment, in accordance with certain embodiments. FIGS. 8B-8E are plots of (b) Potential, (c) Current, (d) Charge, and (e) CO₂ sensor output, each as a function of time, in accordance with certain embodiments.

FIGS. 9A-9E show multiple cycle demonstration of CO₂ capture and release using Fe-EDDHA redox system, in accordance with certain embodiments. FIG. 9A shows cell voltage for 29 cycles at a constant current mode of 5 mA. FIG. 9B shows CO₂ sensor for 29 cycles. FIG. 9C shows captured (alternating curves, including the curve farthest to the left) and released (alternating curves, including the curve farthest to the right) CO₂ amount using 15% CO₂ with flow rate of 5.3 mL/min. FIG. 9D shows the ratio of released CO₂ amount over captured amount as a function of cycle. FIG. 9E shows electron utilization (captured labeled “(a)” and released labeled “(b)”).

FIG. 10A shows X-band EPR spectra of 50 mM Fe-EDDHA in 1 M KNO₃ aqueous solutions without NA collected at 100 K, in accordance with certain embodiments. The curves represent the pristine Fe(III)EDDHA, Fe(II)EDDHA (after electrochemical reduction) and Fe(II)EDDHA with 100% CO₂. The g′=4.3 EPR signals of Fe(III) are located at ~1600 G at the X-band EPR, while Fe(II) in the solutions are not detectable in EPR.

FIG. 10B shows X-band EPR spectra of 50 mM Fe-EDDHA in 1 M KNO₃ aqueous solutions with 1 M NA collected at 100 K, in accordance with certain embodiments. The curves represent the pristine Fe(III)EDDHA, Fe(II)EDDHA (after electrochemical reduction) and Fe(II)EDDHA with 100% CO₂. The g′=4.3 EPR signals of Fe(III) are located at ~1600 G at the X-band EPR, while Fe(II) in the solutions are not detectable in EPR.

FIG. 10C shows X-band EPR spectra of 50 mM reduced Fe(II)EDDHA in 1 M KNO₃ aqueous solutions after bubbling with 100% CO₂ for 2 minutes in the absence of NA and with 1 M NA collected at 100 K, in accordance with certain embodiments. Note here the g′=4.3 EPR signal is from Fe(III) because low-spin Fe(II) is not detectable in EPR.

FIG. 11 shows a photograph of a setup for electrochemical capture and release of CO₂ in cyclic flow, in accordance with certain embodiments.

FIG. 12 shows UV-vis spectra for the CO₂ sensitivity test, in accordance with certain embodiments. The Fe(II)EDDHA solutions in the absence of 1 M NA (curve labeled “(a)”, 50 mM, 4 mL) were bubbled with 15% CO₂ for 20 min at a flow rate of 10 mL/min (curve labeled “(b)”), and air for 20 min at a flow rate of 10 mL/min (curve labeled “(c)”). The curve labeled “(d)” represents UV-vis spectrum of Fe(III)EDDHA.

FIG. 13 shows UV-vis spectra after cyclic flow experiment for 29 cycles, in accordance with certain embodiments. The solutions were exposed to air to be oxidized and measured. The curve labeled “(a)” represents sample from the working electrolyte, and the curve labeled “(b)” from the counter electrolyte.

FIG. 14 shows, in accordance with certain embodiments, ¹³C NMR spectra of Fe(II)EDDHA+1 M NA at varying temperatures.

FIGS. 15A-15E show, in accordance with certain embodiments, additional multiple cycles demonstration of CO₂ capture and release using Fe-EDDHA redox system with assembly of cell components in a glovebox for the extensive air removal. Operations with the constant current mode at 10 mA with 50% capacity usage. Minimum energy requirement was 12.7 kJₑ/mol and the average energy requirement over 14 cycles were 23.9 kJₑ/mol. FIG. 15A shows potential for 14 cycles. FIG. 15B shows CO₂ sensor output. FIG. 15C shows captured (alternating curves, including the curve farthest to the left and the farthest to the right in the unshaded region) and released (curves alternating with the capture curves) CO₂ amount over time using 15% CO₂. FIG. 15D shows the ratio of released CO₂ amount over captured amount. FIG. 15E shows electron utilization (captured labeled “(a)” and released labeled “(b)”).

FIG. 16 shows ¹³C NMR spectra of 1 M NA in D₂O at varying temperatures demonstrating the effects of chemical exchange on NMR spectra, in accordance with certain embodiments.

FIG. 17 shows simulated ¹³C spectra using two-site exchange model, with the fraction of site I ~93% and site II ~7% and the exchange rates of site I to site II varying between 0.05 s⁻¹ and 5 s⁻¹, in accordance with certain embodiments.

FIG. 18 shows ¹³C NMR spectra of 1 M NA+CO₂, 50 mM Fe(III)EDDHA+CO₂, 50 mM Fe(II)EDDHA+CO₂, and 50 mM Fe(II)EDDHA+1 M NA+CO₂, in accordance with certain embodiments.

### DETAILED DESCRIPTION

The pressing issue of climate change driven by human-induced carbon emissions necessitates immediate action to avert a critical tipping point projected for 2050. Mitigation of the surge in atmospheric CO₂ levels (currently at 421 ppm, over 50% higher than pre-industrial levels of approximately 280 ppm) calls for widespread deployment of efficient carbon-capture technologies with minimized energy consumption. Electrochemical carbon-capture processes that have been touted to have the potential to meet these needs generally rely on applied cell voltage and electron utilization (the number of CO₂ molecules separated per electron), which has generally been asserted to have a theoretical limit of 1. Certain aspects of this disclosure relate to an electron-leveraging strategy to enhance electron utilization beyond this limit to 1.43 by employing a redox-active species (e.g., a coordination complex such as Fe-EDDHA) having a ligand with multiple coordination sites (e.g., multiple hemi-labile coordination sites). Enhanced electron utilization (e.g., to 1.43) is attributed, in accordance with certain embodiments, to the dissociation of multiple coordination sites upon electrochemical one-electron reduction of a metal center of a metal complex. For example, in some cases, enhanced electron utilization can be achieved via the dissociation of two phenolate coordination sites upon electrochemical one-electron reduction of the metal center of an iron(3+) complex. Reversibility and robustness of the system can be achieved, in accordance with certain embodiments, via efficient prevention of CO₂ reduction upon the introduction of a guardian of the metal center (e.g., by the introduction of nicotinamide as an iron center guardian of the iron(2+) center). In accordance with certain embodiments, the proof-of-concept cyclic system exhibits a minimum operational energy of 22.6 kJₑ/mol and an average of 63.7 kJₑ/mol over 29 cycles, using 15% CO₂ as a simulated flue gas. The electron-leveraging strategy disclosed herein holds, in accordance with certain embodiments, great promise for advancing energy-efficient electrochemical carbon-capture technologies, and offers an alternative to prevalent redox potential shifting methods proposed to mitigate undesired electron transfer reactions in redox-active materials across diverse operational conditions.

Certain aspects are related to methods of capturing carbon dioxide and related systems. In certain embodiments of the system and/or method, a redox-active species is exposed to carbon dioxide. In certain embodiments, the redox-active species captures carbon dioxide. The capture of the CO₂ can be electrochemically driven, in certain embodiments, such that the transfer of electrons to and from the redox-active species results in the capture and release of CO₂. In certain embodiments, the redox-active species is capable of capturing more than one molecule of CO₂ per electron transferred between the redox-active species and its external environment. The redox-active species may also be capable of releasing more than one molecule of CO₂ per electron transferred between the redox-active species and its external environment.

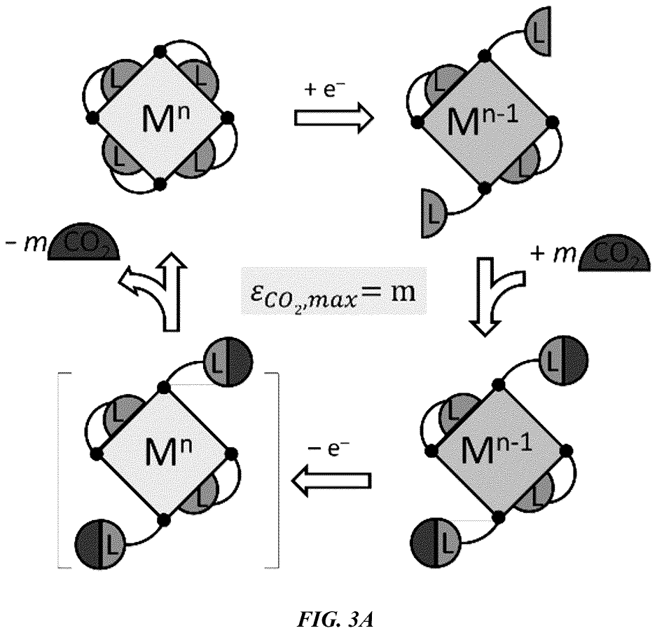

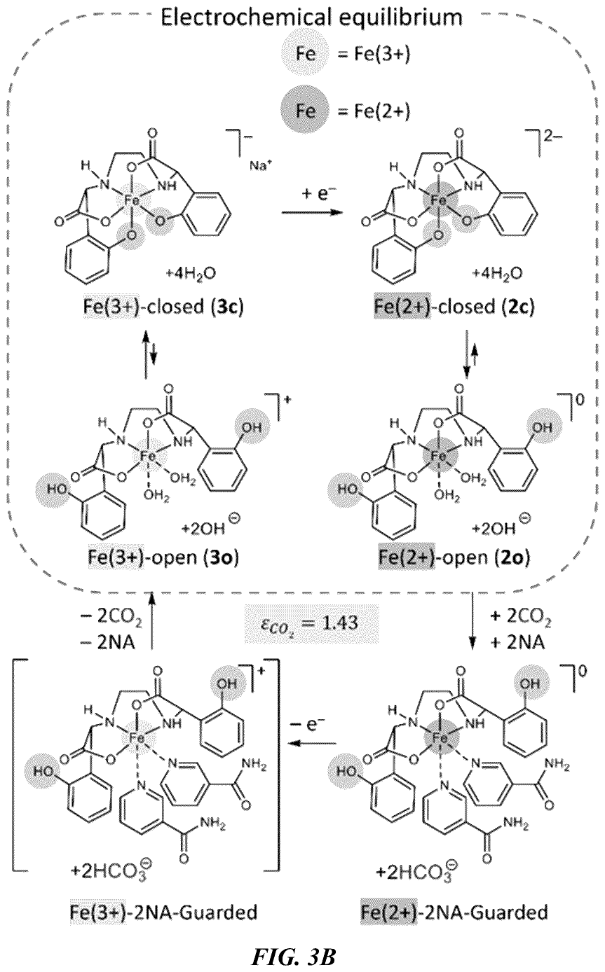

In the context of CO₂ release and capture, the phrase “redox-active species” is used herein to describe all species that participate in the electrochemical reactions that result in the capture and release of CO₂. To illustrate, in some embodiments, ferric ethylenediamine-di-(O-hydroxyphenylacetate) (Fe-EDDHA) can be used as a redox-active species (see, e.g., FIG. 3B). In some such embodiments, Fe-EDDHA can be reduced (e.g., via transfer of an electron to the Fe-EDDHA), resulting in the release of 2 hydroxide ions from the Fe-EDDHA. The hydroxide ions may subsequently react with CO₂ to form 2 HCO₃⁻ ions. In such embodiments, both the Fe-EDDHA and the released hydroxide ions would be considered to be “redox-active species” for the purposes of the present disclosure.

In certain embodiments, transfer of one electron to the redox-active species can result in the capture of more than one molecule of CO₂. In the non-limiting example given above, for example, one electron is transferred to Fe-EDDHA, resulting in the capture of two molecules of CO₂ (via the release of 2 hydroxide ions).

As noted above, electrochemical carbon-capture systems and methods described herein may employ redox-active species, such as redox-active coordination complexes, to facilitate the capture and release of carbon dioxide (CO₂), for example, from gas streams containing CO₂. In some cases, the method and/or system operates by electrochemically modulating the oxidation state of a metal within the redox-active species (e.g., when the redox-active species comprises or is in the form of a coordination complex), thereby altering the chemical properties of the redox-active species. This can allow for reversible CO₂ capture.

Previously, electron utilization was generally considered to have a theoretical upper limit of 1, meaning that at most one CO₂ molecule can be captured or released per electron transferred. Advantageously, in accordance with certain embodiments, the systems and/or methods described herein can have an electron utilization of greater than 1. This can be achieved, for example, by utilizing a redox-active species that is capable of capturing more than one CO₂ molecule per electron transferred to the redox-active species and/or releasing more than one CO₂ molecule per electron transferred from the redox-active species. Electron utilization refers to the number of CO₂ molecules that are captured or released per electron transferred to or away from the redox-active species during the electrochemical process. The phrase “CO₂ capture electron utilization” is used herein to refer to the number of CO₂ molecules that are captured by the redox-active species per electron transferred to the redox-active species. The phrase “CO₂ release electron utilization” is used herein to refer to the number of CO₂ molecules that are released from the redox-active species per electron transferred from the redox-active species.

In certain embodiments, the systems and/or methods described herein may be capable of achieving (and may, in certain embodiments, achieve) electron utilizations (CO₂ capture electron utilization and/or CO₂ release electron utilization) of greater than 1, greater than or equal to 1.01, greater than or equal to 1.05, greater than or equal to 1.10, greater than or equal to 1.15, greater than or equal to 1.2, greater than or equal to 1.25, greater than or equal to 1.3, greater than or equal to 1.35, greater than or equal to 1.4, greater than or equal to 1.43, greater than or equal to 1.45, or greater (e.g., up to 1.5, up to 2, up to 3, up to 4, or greater).

In certain embodiments, electron utilizations of less than 1 can be achieved, but can be larger than the utilizations that would have been achieved if the redox-active species were able to only capture one molecule of carbon dioxide per electron transferred to the redox-active species. For example, in some embodiments, the systems and/or methods described herein may be capable of achieving and/or may achieve electron utilizations (CO₂ capture electron utilization and/or CO₂ release electron utilization) of greater than or equal to 0.1, greater than or equal to 0.2, greater than or equal to 0.3, greater than or equal to 0.5, greater than or equal to 1, greater than or equal to 1.01, greater than or equal to 1.05, greater than or equal to 1.10, greater than or equal to 1.15, greater than or equal to 1.2, greater than or equal to 1.25, greater than or equal to 1.3, greater than or equal to 1.35, greater than or equal to 1.4, greater than or equal to 1.43, greater than or equal to 1.45, or greater (e.g., up to 1.5, up to 2, up to 3, up to 4, or greater). In some such embodiments, the electron utilization can be at least 1.5, at least 1.75, at least 2, at least 3, at least 4, at least 5, or more times the electron utilization that would have been achievable or achieved if the redox-active species were only able to capture one molecule of CO₂ per electron transferred to the redox-active species.

Any of a variety of redox-active species may be used, in accordance with certain embodiments. In some embodiments, the redox-active species comprises a metal complex. The metal complex may comprise a metal atom and one or more organic ligands that form a complex with the metal atom. Any of a variety of metal atoms can be employed including, but not limited to, iron, nickel, magnesium, calcium, cobalt, and/or copper.

In some embodiments, the redox-active species dissociates to form additional molecules and/or ions when it is reduced. For example, as shown in FIG. 3B, the redox-active species dissociates to form a complex and two hydroxide ions upon reduction of the redox-active species.

In some embodiments, the redox-active species can be an organometallic species. The phrase “organometallic species,” as used herein, is used to refer to a species that includes both a metal atom and one or more organic moieties bound to (e.g., via coordination with) the metal atom. The organic moiety can be, for example, an organic ligand.

In certain embodiments, the redox-active species (e.g., redox-active coordination complex) comprises a ligand comprising one or more hemi-labile coordination sites. Hemi-labile ligands are ligands that possess coordination sites capable of reversibly dissociating from the metal center depending on the oxidation state of the metal. In certain embodiments, the redox-active species comprises a ligand with multiple hemi-labile metal coordination sites (e.g., at least two, three, four, five, six, or more hemi-labile metal coordination sites).

In certain embodiments, the redox-active species comprises a ligand that is able to partially dissociate from a metal, creating a closed, stable state and an open, reactive state that switch reversibly during a CO₂ capture and release cycle. In certain embodiments, when the metal center undergoes a change in oxidation state, the equilibrium between ligand-closed and ligand-open conformations may shift. In certain embodiments, this may result in the release or uptake of protons and a corresponding change in the pH of the medium (e.g., solution) containing the redox-active species. This pH change may facilitate the capture or release of multiple CO₂ molecules per electron transferred to or from the redox-active species.

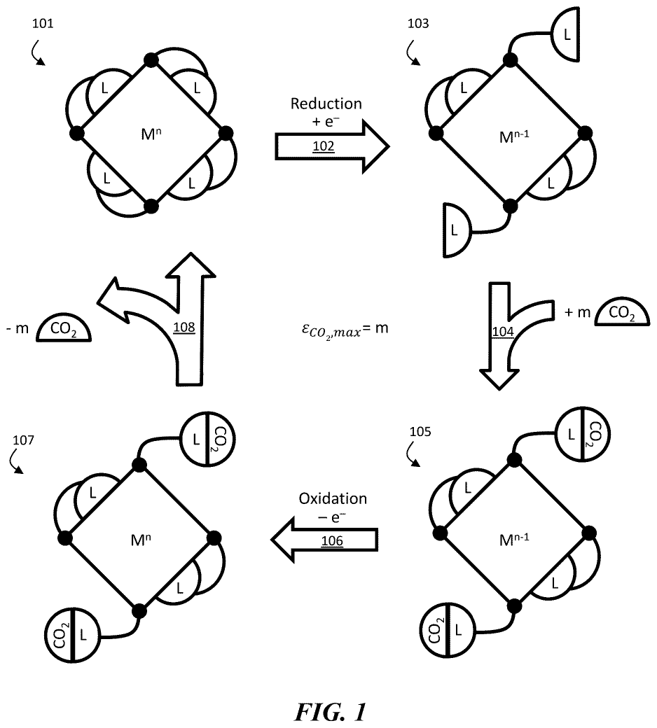

FIG. 1 is a schematic illustration of a method showing the capture and release of CO₂ using a metal complex comprising multiple hemi-labile ligands that transitions between closed and open states. In FIG. 1, “M” denotes the metal (with the superscript to the right of “M” indicating the oxidation state of the metal) and “L” denotes the ligands. In some cases, a redox-active species (e.g., in the form of a coordination complex) in a higher oxidation state may adopt a ligand-closed conformation in which hemi-labile coordination sites are bound to the metal center. For example, in the upper left portion of FIG. 1, the metal of the redox-active species is in an oxidation state of n, and the species has adopted a ligand-closed conformation 101 in which the hemi-labile coordination sites are bound to the metal. In certain embodiments, upon electrochemical reduction, the metal center may transition to a lower oxidation state, causing the equilibrium to shift toward a ligand-open conformation. For example, in FIG. 1, electrochemical reduction step 102 results in the transfer of electrons to the complex such that metal M has an oxidation state of n−1, and the equilibrium has shifted toward a ligand-open conformation 103.

In some embodiments, when the redox-active species is in the ligand-open conformation, the hemi-labile coordination sites may dissociate from the metal center and produce conditions that are favorable for the capture of carbon dioxide. In some embodiments, carbon dioxide can be introduced to the medium (e.g., a liquid solution) containing the redox-active species such that the carbon dioxide is captured. For example, in step 104 of FIG. 1, carbon dioxide is introduced into the medium containing the coordination complex such that the CO₂ is captured by ligands acting as redox-active species, as shown in conformation 105. While the ligands as redox-active species are illustrated in FIG. 1 as being connected to the metal center, the redox-active species need not be so, in accordance with certain embodiments. For example, in some embodiments, when the hemi-labile coordination sites dissociate from the metal center, they may undergo protonation, resulting in a release of hydroxide ions, thereby increasing the pH of the surrounding solution. (See, e.g., FIG. 3B.) The elevated pH may promote the absorption of CO₂ (e.g., from a gas stream) into the solution. For example, CO₂ may react with hydroxide ions within a solution to form HCO₃⁻ ions, resulting in the capture of CO₂.

In certain embodiments, a redox-active species can be used that is capable of capturing more than one molecule of carbon dioxide per electron transferred to the redox-active species. Accordingly, the transfer of a single electron to such redox-active species can, in accordance with certain embodiments, result in the capture of more than one molecule of CO₂. One example of such a redox-active species is shown in FIG. 1. In FIG. 1, after reduction step 102, the redox-active species is reconfigured such that it is able to capture two molecules of CO₂, as shown after step 104. Another example is shown in FIG. 3B. In FIG. 3B, the reduction of the redox-active species forms two hydroxide anions, which results in the capture of two molecules of CO₂ (e.g., in the form of HCO₃⁻). The use of redox-active species having the ability to capture more than one molecule of CO₂ per electron transferred to the redox-active species can lead to system electron utilizations of greater than 1.

In certain embodiments, subsequent electrochemical oxidation of the metal center may restore the ligand-closed conformation. For example, in FIG. 1, electrochemical oxidation step 106 results in the transfer of electrons away from the complex such that metal M has an oxidation state of n within conformation 107. In some embodiments, after the electrochemical oxidation, the complex shifts from a ligand-open conformation to a ligand-closed conformation, and CO₂ is released. For example, in step 108 of FIG. 1, the complex has shifted from a ligand-open conformation 107 back to a ligand-closed conformation 101, and CO₂ is released. As noted above, the CO₂ need not necessarily be bound to the complex, and it may be released via a variety of mechanisms. For example, in some embodiments, as the complex shifts back to a ligand-closed conformation, protons may be released, decreasing the solution pH, which may drive the liberation of captured CO₂. (See, e.g., FIG. 3B.)

In accordance with certain embodiments, the number of hemi-labile coordination sites present on the ligand may determine the maximum theoretical electron utilization value. For example, a coordination complex having a ligand with two hemi-labile coordination sites may achieve an electron utilization value of up to two, meaning that up to two CO₂ molecules may be captured or released per electron transferred. The electron-leveraging strategy may be extended to achieve higher electron utilization values by utilizing coordination complexes with additional hemi-labile coordination sites. For example, coordination complexes having ligands with three hemi-labile coordination sites may provide for 3× leveraged systems, in which up to three CO₂ molecules may be captured or released per electron transferred. Similarly, coordination complexes having ligands with four hemi-labile coordination sites may provide for 4× leveraged systems, in which up to four CO₂ molecules may be captured or released per electron transferred. The maximum theoretical electron utilization value may correspond to the number of hemi-labile coordination sites present on the ligand. By designing and selecting coordination complexes with ligands having multiple hemi-labile coordination sites, electrochemical carbon-capture systems may achieve enhanced electron utilization and reduced energy consumption compared to systems limited to electron utilization values of one or less.

As noted above, any of a variety of redox-active species may be employed in the systems and methods described herein. In some embodiments, the redox-active species comprises a metal “center” complexed with a ligand component. For example, in the case of ferric ethylenediamine-di-(o-hydroxyphenylacetate) (Fe-EDDHA), iron serves as the metal center while EDDHA serves as the ligand component. In certain embodiments, the ligand component of the redox-active species includes multiple coordination sites that, when reduced, result in the release of hydroxide ions. For example, the ligand component of the redox-active species may include multiple phenolate ligands. The release of the hydroxide ions may, in accordance with certain embodiments, result in the capture of CO₂, for example, in the form of HCO₃⁻ ions. In certain embodiments, the ligand component of the redox-active species includes multiple coordination sites that, when reduced, react and/or bond with CO₂ such that the CO₂ is captured.

In certain embodiments, the redox-active species comprises iron, nickel, magnesium, calcium, copper, or cobalt as the metal “center.” A variety of ligand components can be used including, but not limited to, ethylenediaminetetra-acetic acid, ethylenediamine dis(2-hydroxyphenyl)acetic acid (EDDHA), ethylenediamine-N,N-bis(2-hydroxy-5-sulfophenylacetic) acid (EDDHSA), aminopoly (carboxylic acids) (such as, for example, ethylenediaminetetraacetic acid (EDTA), nitrilotriacetic acid (NTA), and hydroxyethylethylenediaminetriacetic acid (HEDTA)), nicotine, (2-aminoethyl)bis-(2-pyridylmethyl)amine (DPEA), citrate, dimethyl sulfoxide (DMSO), glycine, malic acid, and malonic acid. Specific examples of complexes that can be used as redox-active species include, but are not limited to, Ni(II)-ethylenediaminetetra-acetic acid, Mg(II)-EDDHA, Ca(II)-EDDHA, Cu(II)-EDDHA, Fe(III)-EDDHA, Fe(III)-EDDHSA, Fe-aminopoly (carboxylic acids), Fe(II)-DPEA, Fe-citrate, Fe-DMSO, Fe-glycine, Fe-malic acid, and Fe-malonic acid. In certain embodiments, it can be particularly advantageous for the redox-active species to comprise ferric ethylenediamine-di-(o-hydroxyphenylacetate) (Fe-EDDHA).

In certain embodiments, the redox-active species can be accompanied by a guardian. For example, in certain embodiments, both the redox-active species and the guardian may be present in a solution or suspension. In certain embodiments, the guardian interacts with the electron orbitals of the metal center (e.g., by causing d-orbital splitting), which can lead to strong bonding interactions with the metal center. In some embodiments, CO₂ reduction of the metal is prevented by a guardian that protects a metal of the redox-active species. For example, the strong bonding interactions between the guardian and the metal center can, in certain embodiments, effectively disable CO₂ reduction catalysis by sterically obstructing the approach of CO₂ to the metal center.

Any of a variety of materials can be used as a guardian, in accordance with certain embodiments. In some embodiments, the guardian comprises a nitrogen-containing heterocyclic compound. Non-limiting examples of guardians include pyridine-3-carboxylic acid amide (nicotinamide); pyridine-4-carboxamide (isonicotinamide); 4-dimethylaminopyridine (DMAP); 1,8-Diazabicyclo[5.4.0]undec-7-ene (DBU); 3,5-Dimethylisonicotinamide; 1-Methylimidazole; Benzimidazole; 1,3-Bis(2,4,6-trimethylphenyl)-1,3-dihydro-2H-imidazol-2-ylidene (IMes); and 2,2′-Bipyridine (bpy).

In certain embodiments, the redox-active species can be part of a fluid medium (e.g., a liquid, a mixture of a liquid and a gas, or any other suitable fluid) that is used to capture carbon dioxide. The fluid medium can be, for example, a solution or suspension. In some embodiments, it can be particularly advantageous for the redox-active species to be in a solution, such as an aqueous solution. For example, in one set of embodiments, the Fe-EDDHA is in an aqueous solution. In certain embodiments, the fluid medium can also comprise an electrolyte. The electrolyte can support the electrochemical function of an electrochemical cell within which the fluid medium is located. As one example, the electrolyte can comprise potassium nitrate (KNO₃). Other electrolytes can also be used and can generally be selected by choosing a compound (e.g., a salt) that provides ions capable of supporting electrolytic function while avoiding undesirable side reactions with the redox-active species.

In some embodiments, the fluid medium (e.g., liquid solution) comprises redox-active species at a concentration of greater than or equal to 10 mM, greater than or equal to 50 mM, greater than or equal to 100 mM, greater than or equal to 200 mM, greater than or equal to 500 mM, and/or up to 1 M, up to 2 M, or greater. In some embodiments, the fluid medium (e.g., liquid solution) comprises the guardian at a concentration of greater than or equal to 10 mM, greater than or equal to 50 mM, greater than or equal to 100 mM, greater than or equal to 200 mM, greater than or equal to 500 mM, and/or up to 1 M, up to 2 M, or greater.

In some embodiments, the redox-active species electrochemically captures carbon dioxide. For example, certain embodiments comprise applying an electrical potential to an electrochemical cell within which the redox-active species is present to capture carbon dioxide.

In certain embodiments, the systems and methods described herein can employ an electrochemical cell. The system, for example, can be an electrochemical system in which the redox-active species is configured to capture carbon dioxide when an electrical potential is applied to the electrochemical cell. The system may also release the carbon dioxide in another location when an electrical potential is applied to the electrochemical cell.

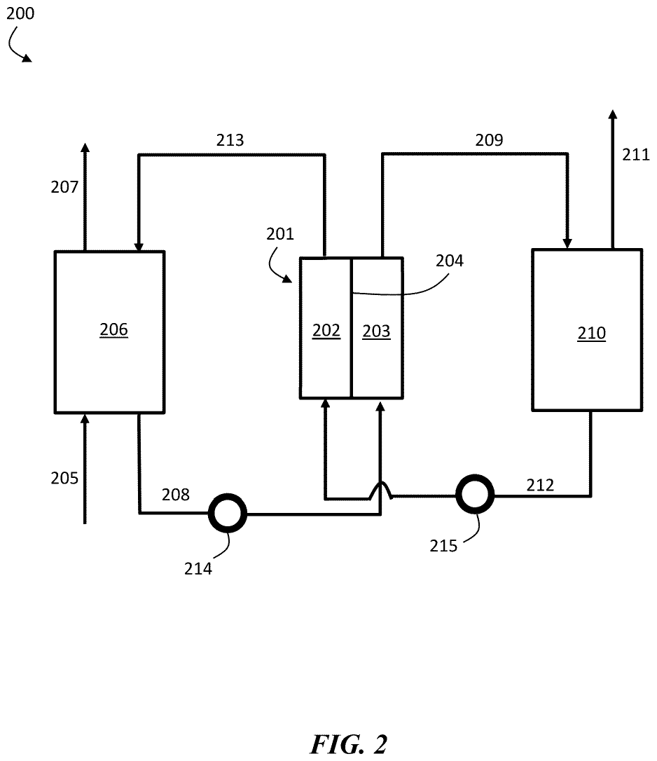

FIG. 2 is a schematic diagram of an exemplary system 200 comprising an electrochemical cell 201. The term “electrochemical cell,” as used herein refers to an apparatus in which redox half reactions take place at negative and positive electrodes. The term “electrochemical cell” is intended to include apparatuses that meet these criteria even where the behavior of the cell could arguably be characterized as more pseudocapacitive than Faradaic and thus might otherwise be referred to as a type of capacitor. In certain cases, the electrochemical cell is suitable for reacting with carbon dioxide from gas mixtures in any of a variety of applications including at least partially separating carbon dioxide from mixtures having relatively low concentrations of carbon dioxide (e.g., ambient air, ventilated air, etc.).

As used herein, the “anode side” of an electrochemical cell refers to the side into which electrons are injected when energy is input into the electrochemical cell (e.g., via a charging process). For example, referring to FIG. 2, when energy is input into electrochemical cell 201 (e.g., via the application of a potential by an external power source), electrons pass through an external circuit (not shown) and into anode side 202. As such, in some cases, redox-active species within the anode side of the electrochemical cell can be reduced to a reduced state (a state having an increased number of electrons) during a charging process of the electrochemical cell.

As used herein, the “cathode side” of an electrochemical cell refers to the side from which electrons are removed when energy is input into the electrochemical cell (e.g., via a charging process). For example, referring again to FIG. 2, when energy is input into electrochemical cell 201 (e.g., via the application of a potential by an external power source), electrons pass from cathode side 203 and into an external circuit (not shown). As such, in some cases, species contained within the cathode side of the electrochemical cell can be oxidized to an oxidized state (a state having a decreased number of electrons) during a charging process of the electrochemical cell.

Anode side 202 and cathode side 203 can be separated by a separator 204. The separator can, in certain embodiments, allow for the shuttling of electrolyte ions between the anode side and the cathode side while maintaining electronic insulation between the anode side and the cathode side. In some cases, the electrochemical cell may include a cation exchange membrane configured to separate the cathode side from the anode side. The cation exchange membrane may divide the electrochemical cell into two reaction chambers while allowing for a pH difference between the cathode side and the anode side to be maintained during operation. The cation exchange membrane may allow cations to pass between the anode side and the cathode side while preventing mixing of the catholyte and anolyte solutions, thereby preserving the pH gradient generated by the electrochemical reduction and oxidation processes.

In accordance with certain embodiments, the electrochemical cell is configured to electrochemically reduce and oxidize the metal center of the redox-active species to allow for the localized capture and release of carbon dioxide. For example, in accordance with certain embodiments, the reduction of the redox-active species within anode side 202 of electrochemical cell 201 can lead to the formation of a ligand-open conformation of the redox-active species as shown, for example, as element 103 of FIG. 1. The formation of the ligand-open conformation can lead to the capture of CO₂, as illustrated, for example, in step 104 of FIG. 1. In addition, the oxidation of the redox-active species within cathode side 203 of electrochemical cell 201 can lead to the formation of a ligand-closed conformation of the redox-active species as shown, for example, in element 101 of FIG. 1. The formation of the ligand-closed conformation can be accompanied by the release of CO₂, as illustrated, for example, in step 108 of FIG. 1.

In some cases, the cathode side and/or the anode side may be equipped with a porous, electronically conductive medium (e.g., porous carbon or metal electrodes, such as graphite felt electrodes). The porous, electronically conductive medium may increase the efficiency with which electrons are transferred from outside the electrochemical cell to the redox-active species, and vice-versa.

The electrochemical cell can be operated continuously, in accordance with certain embodiments, allowing for capture of carbon dioxide from one region (e.g., from the atmosphere) and release of the carbon dioxide in another region (e.g., a sequestration site). Referring to system 200 in FIG. 2, for example, the system is arranged such that liquid anolyte and catholyte are flowed through anode side 202 and cathode side 203, respectively, allowing for continuous operation of electrochemical cell 201.

In some embodiments, the electrochemical carbon-capture system may operate through a pH-swing mechanism in which the pH of the solution containing the redox-active species changes in response to electrochemical reduction and oxidation of the metal center. For example, in some embodiments, a fluid medium comprising the redox-active species may be exposed to a stream comprising carbon dioxide such that carbon dioxide is dissolved into the fluid medium. The dissolved carbon dioxide may be present in the fluid medium as (a) the dissolved carbon dioxide molecules themselves (CO_{2(aq)}), (b) the corresponding Bronsted-Lowry acid as carbonic acid (H₂CO_{3(aq)}), and/or (c) one or more conjugate bases of the Bronsted-Lowry acid as bicarbonate (HCO₃⁻_{(aq)}) and/or carbonate (CO₃²⁻_{(aq)}). In some embodiments, each of (a), (b), or (c) are present in the liquid solution at an acid-base equilibrium. The equilibria may be as follows:

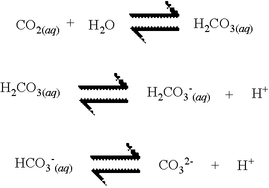

In some embodiments, during the reduction process, the pH of the fluid medium may increase (e.g., from approximately 6.8 to approximately 9.0). This pH increase may be attributed to the weak basicity of the ligand when the metal complex is in the open conformation. When the ligands dissociate from the metal center upon electrochemical reduction, the ligands may accept protons from the surrounding aqueous solution, thereby consuming protons and increasing the pH of the fluid medium.

In certain embodiments, the reduction process can lead to an increase in pH of the fluid medium (relative to the pH of the fluid medium prior to the reduction) by at least 0.1 pH units, at least 0.2 pH units, at least 0.5 pH units, at least 1 pH unit, at least 1.5 pH units, at least 2 pH units, at least 3 pH units, and/or up to 2.2 pH units, up to 3 pH units, up to 4 pH units, up to 5 pH units, up to 6 pH units, or more. Combinations of these ranges are also possible.

The elevated solution pH resulting from the electrochemical reduction may facilitate the capture of CO₂ from a gas stream contacted with the aqueous electrolyte. At higher pH values, the carbonate equilibrium in the aqueous electrolyte may shift to favor the absorption of CO₂ from the gas phase into the liquid phase. The CO₂ may dissolve in the fluid medium and react with hydroxide ions to form bicarbonate and carbonate species, which may remain dissolved in the fluid medium. The pH increase (e.g., from 6.8 to 9.0) may provide sufficient alkalinity to drive CO₂ absorption from diluted CO₂ feed gases such as simulated flue gas.

Upon introduction of a CO₂-containing gas stream to the reduced fluid medium, the fluid medium may reach a steady-state pH (e.g., of approximately 7.3) as CO₂ absorption proceeds. The decrease in pH during CO₂ contact may reflect the consumption of alkalinity as CO₂ dissolves and reacts with hydroxide ions in the fluid medium. During a subsequent oxidation process, the metal center may be oxidized. The oxidation may cause the ligands to re-coordinate to the metal center, transitioning from the open conformation back to the closed conformation. As the ligands coordinate to the metal center, the ligands may release protons into the aqueous solution, thereby decreasing the pH of the fluid medium. The decrease in fluid medium pH during the oxidation process may drive the liberation of captured CO₂ from the aqueous solution. At lower pH values, the carbonate equilibrium may shift to favor the release of dissolved CO₂ from the liquid phase into the gas phase. The bicarbonate and carbonate species that were formed during CO₂ absorption may react with the released protons to regenerate CO₂ gas, which may be released from the fluid medium. The pH-swing mechanism may allow for the reversible capture and release of CO₂ by cycling an aqueous solution between high pH conditions that favor CO₂ absorption and low pH conditions that favor CO₂ release.

In certain embodiments, the oxidation process can lead to a decrease in pH of the fluid medium (relative to the pH prior to the oxidation of the fluid medium) by at least 0.1 pH units, at least 0.2 pH units, at least 0.5 pH units, at least 1 pH unit, at least 1.5 pH units, at least 2 pH units, at least 3 pH units, and/or up to 2.2 pH units, up to 3 pH units, up to 4 pH units, up to 5 pH units, up to 6 pH units, or more. Combinations of these ranges are also possible.

One example of a mode of operation is now provided, with reference to system 200 in FIG. 2. Stream 205 that is relatively rich in CO₂ can be transported to vessel 206, which can contain the reduced redox-active species in a ligand-open conformation. The reduced redox-active species in ligand-open conformation in vessel 206 can capture CO₂ from the CO₂-rich stream (as illustrated schematically, for example, in step 104 of FIG. 1), resulting in the formation of a CO₂-lean gas stream 207 and stream 208 containing captured CO₂. In some embodiments, at least 0.1 mol %, at least 1 mol %, at least 5 mol %, at least 10 mol %, at least 25 mol %, at least 50 mol %, at least 75 mol %, at least 90 mol %, at least 95 mol %, or at least 99 mol % of the CO₂ within the CO₂-rich stream can be captured by the stream containing the redox-active species.

Stream 208 can be transported (e.g., via pump 214) to cathode side 203 of electrochemical cell 201. Within cathode side 203, the redox-active species can undergo oxidation (as illustrated schematically, for example, in step 106 of FIG. 1), resulting in a transformation of the redox-active species into a ligand-closed conformation and the release of CO₂ (as illustrated schematically, for example, in step 108 of FIG. 1). In some embodiments, at least 0.1 mol %, at least 5 mol %, at least 10 mol %, at least 25 mol %, at least 50 mol %, at least 75 mol %, at least 90 mol %, at least 95 mol %, at least 99 mol %, or all of the CO₂ that was captured by the stream containing the redox-active species can be released from the redox-active species in this step.

The released CO₂ and the oxidized redox-active species can be separated, for example, in vessel 210 to produce stream 211 of concentrated CO₂ and stream 212 of oxidized redox-active species in ligand-closed conformation. In some embodiments, stream 211 can include at least 0.1 mol %, at least 1 mol %, at least 5 mol %, at least 10 mol %, at least 25 mol %, at least 50 mol %, at least 75 mol %, at least 90 mol %, at least 95 mol %, at least 99 mol %, or all of the CO₂ that was captured by the stream containing the redox-active species.

The oxidized redox-active species in stream 212 can be transported (e.g., via pump 215) to anode side 202 where the redox-active species can undergo reduction (as illustrated schematically, for example, in step 102 of FIG. 1) such that the redox-active species is transformed to a ligand-open conformation. Redox-active species in ligand-open conformation can then be transported via stream 213 to vessel 206, where the process can begin again. In certain embodiments, redox-active species can be cycled at least 10, at least 15, at least 20, at least 25, at least 30, at least 50, at least 100, or more (e.g., up to 200, up to 500, up to 1000, or more) times.

In certain embodiments, the system and/or method employing the redox-active species may demonstrate a relatively high electron utilization over a large number of CO₂ capture and release cycles. For example, in some embodiments, over at least 10, at least 15, at least 20, at least 25, at least 30, at least 50, at least 100, or more (e.g., up to 200, up to 500, up to 1000, or more) CO₂ capture and release cycles, the system and/or method can be capable of achieving and/or can achieve an average electron utilization (e.g., a CO₂ capture electron utilization and/or a CO₂ release electron utilization) of greater than 1, greater than or equal to 1.01, greater than or equal to 1.05, greater than or equal to 1.10, greater than or equal to 1.15, greater than or equal to 1.2, greater than or equal to 1.25, greater than or equal to 1.3, greater than or equal to 1.35, greater than or equal to 1.4, greater than or equal to 1.43, greater than or equal to 1.45, or greater (e.g., up to 1.5, up to 2, up to 3, up to 4, or greater). In some embodiments, for each CO₂ capture and release cycle over at least 10, at least 15, at least 20, at least 25, at least 30, at least 50, at least 100, or more (e.g., up to 200, up to 500, up to 1000, or more) CO₂ capture and release cycles, the system and/or method can be capable of achieving and/or can achieve an electron utilization (e.g., a CO₂ capture electron utilization and/or a CO₂ release electron utilization) of greater than 1, greater than or equal to 1.01, greater than or equal to 1.05, greater than or equal to 1.10, greater than or equal to 1.15, greater than or equal to 1.2, greater than or equal to 1.25, greater than or equal to 1.3, greater than or equal to 1.35, greater than or equal to 1.4, greater than or equal to 1.43, greater than or equal to 1.45, or greater (e.g., up to 1.5, up to 2, up to 3, up to 4, or greater).

In certain embodiments, electron utilizations of less than 1 can be achieved, but can be maintained over multiple cycles and can be larger than the utilizations that would have been achieved if the redox-active species were able to only capture one molecule of carbon dioxide per electron transferred to the redox-active species. For example, in some embodiments, over at least 10, at least 15, at least 20, at least 25, at least 30, at least 50, at least 100, or more (e.g., up to 200, up to 500, up to 1000, or more) CO₂ capture and release cycles, the systems and/or methods described herein can be capable of achieving and/or can achieve an average electron utilization (CO₂ capture electron utilization and/or CO₂ release electron utilization) of greater than or equal to 0.1, greater than or equal to 0.2, greater than or equal to 0.3, greater than or equal to 0.5, greater than or equal to 1, greater than or equal to 1.01, greater than or equal to 1.05, greater than or equal to 1.10, greater than or equal to 1.15, greater than or equal to 1.2, greater than or equal to 1.25, greater than or equal to 1.3, greater than or equal to 1.35, greater than or equal to 1.4, greater than or equal to 1.43, greater than or equal to 1.45, or greater (e.g., up to 1.5, up to 2, up to 3, up to 4, or greater), and the average electron utilization can be at least 1.5, at least 1.75, at least 2, at least 3, at least 4, at least 5, or more times the average electron utilization that would have been achievable and/or achieved if the redox-active species were only capable of capturing one molecule of CO₂ per electron transferred to the redox-active species. In some embodiments, for each CO₂ capture and release cycle over at least 10, at least 15, at least 20, at least 25, at least 30, at least 50, at least 100, or more (e.g., up to 200, up to 500, up to 1000, or more) CO₂ capture and release cycles, the systems and/or methods described herein can be capable of achieving and/or can achieve an electron utilization (CO₂ capture electron utilization and/or CO₂ release electron utilization) of greater than or equal to 0.1, greater than or equal to 0.2, greater than or equal to 0.3, greater than or equal to 0.5, greater than or equal to 1, greater than or equal to 1.01, greater than or equal to 1.05, greater than or equal to 1.10, greater than or equal to 1.15, greater than or equal to 1.2, greater than or equal to 1.25, greater than or equal to 1.3, greater than or equal to 1.35, greater than or equal to 1.4, greater than or equal to 1.43, greater than or equal to 1.45, or greater (e.g., up to 1.5, up to 2, up to 3, up to 4, or greater), and the electron utilizations can be at least 1.5, at least 1.75, at least 2, at least 3, at least 4, at least 5, or more times the electron utilizations that would have been achievable and/or achieved if the redox-active species were only capable of capturing one molecule of CO₂ per electron transferred to the redox-active species.

The systems and/or methods described herein can be used to capture and/or release a relatively large amount of CO₂. For example, in some embodiments, the system and/or method can capture at least 1, at least 2, at least 5, at least 10, at least 100, or more moles of CO₂.

In certain embodiments, the system and/or method employing the redox-active species may utilize a relatively low amount of energy. For example, in some embodiments, the system and/or method can capture at least 1, at least 2, at least 5, at least 10, at least 100, or more moles of CO₂ while achieving an operational energy consumption of less than or equal to 1,000, less than or equal to 500, less than or equal to 100, less than or equal to 50, less than or equal to 30, or less than or equal to 25 kJ per mole of CO₂ captured. In some embodiments, the system and/or method can capture at least 1, at least 2, at least 5, at least 10, at least 100, or more moles of CO₂ while achieving an operational energy consumption of as little as 23, as little as 22, as little as 20, as little as 15, or as little as 10 kJ per mole of CO₂ captured.

The systems and methods described herein can be used to remove carbon dioxide from a variety of streams generated by a variety of systems. For example, in some embodiments, the systems and/or methods described herein can be used to remove carbon dioxide from an exhaust stream (e.g., an exhaust stream from a power plant, an internal combustion engine, a pyro-processing furnace (e.g., as used in the cement industry), and/or from a stream from a hydrogen generation process (e.g., by sorption enhanced steam reforming (SESR)) and/or from the ambient environment.

The concentration of the carbon dioxide in the carbon dioxide containing gaseous stream that is input to the systems and methods described herein (e.g., stream 205 in FIG. 2) can be within any of a variety of ranges. In some embodiments, the carbon dioxide containing gaseous stream that is input to the systems and methods described herein can have a relatively low concentration of CO₂ (e.g., less than or equal to 1 mol %, less than or equal to 0.1 mol %, less than or equal to 0.05 mol %, or less). Streams comprising larger amounts of CO₂ (e.g., containing carbon dioxide in an amount of at least 1 mol %, at least 2 mol %, at least 5 mol %, at least 10 mol %, at least 20 mol %, at least 30 mol %, at least 40 mol %, at least 50 mol %, at least 75 mol %, at least 90 mol %, at least 95 mol %, at least 99 mol %, or at least 99.9 mol % and/or less than or equal to 90 mol %, less than or equal to 80 mol %, less than or equal to 70 mol %, less than or equal to 60 mol %, less than or equal to 50 mol %, or less) can also be processed using the systems and methods described herein.

In some embodiments, the concentration of oxygen in the carbon dioxide containing gaseous stream that is input to the systems and methods described herein (e.g., stream 205 in FIG. 2) can be relatively high. In some embodiments, the presence of oxygen in such streams does not substantially interfere with the operation of the system or method, for example, due to the presence of the guardian species, which can resist oxidation of the metal center of the redox-active species. In some embodiments, the carbon dioxide containing gaseous stream that is input to the systems and methods described herein comprises O₂ in an amount of at least 1 mol %, at least 2 mol %, at least 5 mol %, at least 10 mol %, or at least 20 mol % (and/or, in some embodiments, up to 21 mol %, up to 25 mol %, or more).

In certain embodiments, an electrochemical carbon-capture system is provided. The electrochemical carbon-capture system can comprise an aqueous electrolyte comprising a redox-active coordination complex having a metal center and a ligand with at least two hemi-labile coordination sites. In some embodiments, the hemi-labile coordination sites are configured to reversibly dissociate from the metal center upon a change in oxidation state of the metal center. In some embodiments, a metal center guardian compound dissolved in the aqueous electrolyte is present. In certain embodiments, the metal center guardian compound is configured to coordinate to the metal center when the hemi-labile coordination sites are dissociated, thereby inhibiting electron transfer from the metal center to carbon dioxide. In certain embodiments, the system comprises an electrochemical cell configured to electrochemically reduce and oxidize the metal center to modulate a pH of the aqueous electrolyte for capture and release of carbon dioxide. In certain embodiments, the metal center comprises iron. In some embodiments, the redox-active coordination complex comprises ferric ethylenediamine-di-(o-hydroxyphenylacetate) (Fe-EDDHA). In certain embodiments, the metal center is configured to transition between an iron(III) oxidation state and an iron(II) oxidation state upon electrochemical reduction and oxidation. In some embodiments, the hemi-labile coordination sites comprise phenolate groups. In certain embodiments, the phenolate groups are configured to dissociate from the metal center and undergo protonation upon electrochemical reduction of the metal center, thereby increasing the pH of the aqueous electrolyte. In certain embodiments, the metal center guardian compound comprises a pyridine derivative. In some embodiments, the metal center guardian compound comprises nicotinamide. In some embodiments, the aqueous electrolyte further comprises a supporting electrolyte. In certain embodiments, the supporting electrolyte comprises potassium nitrate.

Certain embodiments are directed to a method for electrochemical carbon capture. In some embodiments, the method comprises providing an aqueous electrolyte comprising a redox-active coordination complex having a metal center and a ligand with at least two hemi-labile coordination sites, and a metal center guardian compound. Certain embodiments comprise electrochemically reducing the metal center from a first oxidation state to a second oxidation state, wherein the reduction causes the hemi-labile coordination sites to dissociate from the metal center and undergo protonation, thereby increasing a pH of the aqueous electrolyte. Some embodiments comprise contacting the aqueous electrolyte with a carbon dioxide-containing gas stream to capture carbon dioxide in the aqueous electrolyte. Certain embodiments comprise electrochemically oxidizing the metal center from the second oxidation state to the first oxidation state, wherein the oxidation causes the hemi-labile coordination sites to coordinate to the metal center and release protons, thereby decreasing the pH of the aqueous electrolyte and releasing the captured carbon dioxide. In some embodiments, the metal center comprises iron, the first oxidation state is an iron(III) oxidation state, and the second oxidation state is an iron(II) oxidation state. In certain embodiments, the redox-active coordination complex comprises ferric ethylenediamine-di-(o-hydroxyphenylacetate) (Fe-EDDHA). In some embodiments, the metal center guardian compound comprises nicotinamide, and the nicotinamide coordinates to the metal center when the hemi-labile coordination sites are dissociated to sterically inhibit carbon dioxide from approaching the metal center. In some embodiments, the hemi-labile coordination sites comprise phenolate groups, and the phenolate groups undergo protonation upon dissociation from the metal center. In certain embodiments, the carbon dioxide-containing gas stream comprises a flue gas, ambient air, or an exhaust gas.

Certain aspects are related to an aqueous electrolyte composition for electrochemical carbon capture. In some embodiments, the electrolyte composition comprises a redox-active iron coordination complex comprising an iron center coordinated to an ethylenediamine-di-(o-hydroxyphenylacetate) ligand, wherein the ligand comprises at least two phenolate coordination sites configured to reversibly dissociate from the iron center upon electrochemical reduction of the iron center. In certain embodiments, the electrolyte composition comprises a pyridine-based metal center guardian compound configured to coordinate to the iron center when the phenolate coordination sites are dissociated. In some embodiments, the electrolyte composition comprises a supporting electrolyte. In some embodiments, the pyridine-based metal center guardian compound comprises nicotinamide. In certain embodiments, the nicotinamide is present at a concentration of approximately 1 M. In some embodiments, the supporting electrolyte comprises potassium nitrate.

Certain aspects are related to a carbon-capture process comprising a symmetric cyclic electrochemical system, wherein the system comprises a redox-active organometallic species comprising a ligand with multiple hemi-labile iron coordination sites. In some embodiments of the carbon-capture process, CO₂ reduction is prevented by the introduction of pyridine-3-carboxylic acid amide (nicotinamide) as an iron center guardian of the iron(2+) center. In certain embodiments of the carbon-capture process, the redox-active organometallic species comprises ferric ethylenediamine-di-(o-hydroxyphenylacetate) (Fe-EDDHA) in an aqueous solution with potassium nitrate (KNO₃) as an electrolyte. In some embodiments of the carbon-capture process, Fe-EDDHA is at a 50 mmol concentration and 1 M KNO₃. In certain embodiments of the carbon-capture process, the guardian comprises nicotinamide, for example, at a concentration of around 1 M. In some embodiments of the carbon-capture process, a 15% CO₂ gas stream is introduced.

The following example is intended to illustrate certain embodiments of the present invention, but does not exemplify the full scope of the invention.

### Example

Climate change associated with anthropogenic carbon emissions has emerged as a foremost challenge to global stability, requiring immediate attention to prevent reaching a critical tipping point by 2050. It is believed that widespread deployment of carbon-capture technologies with minimized energy consumption will be required to effectively reduce elevated atmospheric carbon dioxide (CO₂) levels (currently at 421 ppm, over 50% higher than pre-industrial levels of approximately 280 ppm). Post-combustion carbon capture from concentrated sources, such as coal-fired power plants, plays a critical role in the transition towards net-zero emissions, and when combined with complementary technologies like direct air capture, it holds the potential to contribute to net-negative emissions, thus helping to mitigate the long-term impacts of climate change. Electrochemical carbon-capture systems have emerged as a promising avenue to address the limitations inherent in established thermal carbon-capture processes that rely on aqueous amine solutions. These thermal systems generally suffer from the primary concerns of energy-inefficient regeneration and the environmental impacts stemming from the volatility of amines and the disposal of degraded amine solutions. In contrast, electrochemical systems offer inherent advantages such as isothermal conditions, plug-and-play operation, and modular scalability, with significant potential for the development of energy-efficient carbon-capture processes. Recent advancements in the design and utilization of non-volatile molecular redox-active materials for electrochemical carbon-capture systems have, for instance, shown promise in achieving more environmentally benign processes.

Recent research in electrochemical carbon-capture systems has focused on reducing separation energy consumption (Eₛₑₚ, Eq. 1) by adjusting the electrochemical cell potential (E_{cell}, Eq. 1) and maximizing electron utilization (ε_{CO2}, Eq. 2). While ε_{CO2} typically has a theoretical limit of 1, efforts to reduce energy consumption even further require surpassing this limit. Separation energy (Eₛₑₚ) can be calculated as follows:

$${E}_{sep} = \frac{\int IVdt}{\int {\dot{n}}_{{CO}_{2}} dt} = \frac{{n}_{e l e c tron} {FE}_{cell}}{{n}_{{CO}_{2}}} = \frac{F {E}_{cell}}{{ε}_{{CO}_{2}}} \qquad ( Eq . 1 )$$

where n_{electron}(=∫Idt/F) is total moles of electrons transferred to the system, F is Faraday's constant (96.5 kC/mol), \dot{n}_{CO}_{₂} is the instantaneous rate of release of CO₂, and n_{CO}_{₂} is total moles of CO₂ released. Electron utilization (ε_{CO2}) can be calculated as follows:

$${ε}_{{CO}_{2}} = \frac{{n}_{{CO}_{2}}}{{n}_{electron}} \qquad ( Eq . 2 )$$

To achieve greater reductions in energy consumption, a focus of the present disclosure was to develop an electron-leveraging strategy aimed at increasing electron utilization values beyond unity. This pursuit involves the design of redox-active compounds with the ability to capture multiple CO₂ molecules per electron transferred. This example introduces a significant advancement by utilizing hemi-labile ligands. These ligands, with their coordination and proton affinities dependent on oxidation state, expand the molecular search space beyond the limitations imposed by coordination number changes, which are observed in only a few metals and specific ligand environments. Moreover, this example provides robust experimental validation of this enhanced electron-leveraging approach, demonstrating its practical applicability in electrochemical carbon capture. FIG. 3A illustrates the features that can be used for the electron-leveraging strategy in the electrochemical carbon-capture process, which include: (1) utilization of a complex (+n oxidation state) with ligands involving a number m of hemi-labile coordination sites, (2) occurrence of electrochemical electron transfers at the metal center, (3) alteration of the metal center's oxidation state from +n to +(n−1) leading to a shift in equilibrium between ligand-closed and ligand-open conformations of the m coordination sites, and (4) capture of CO₂ by the ligand-open conformation with a maximum electron utilization value of m.

To demonstrate the concept of an electron-leveraging electrochemical carbon-capture system, redox-active ferric ethylenediamine-di-(o-hydroxyphenylacetate) (Fe-EDDHA), a commercially available fertilizer, was selected. In this system, depicted in FIG. 3B, Fe(III)-EDDHA-closed (3c) in an aqueous electrolyte is electrochemically reduced by a single electron transfer to form Fe(II)-EDDHA-closed (2c). The Fe(II)-EDDHA-closed (2c) exists in equilibrium with the Fe(II)-EDDHA-open (20) form. Notably, the two phenolate ligands are dissociated from the iron center and undergo protonation, leading to an increase in the pH of the electrolyte. This elevated solution pH facilitates the capture of CO₂ from the diluted CO₂ feed gas. Once the solution becomes saturated with CO₂, an electrochemical oxidation results in the formation of Fe(III)-EDDHA-open (3o), which rapidly converts back to the closed conformation (3c), releasing protons to decrease the pH and hence drive the release of CO₂.

To ensure the reversibility and efficiency of an electrochemical carbon-capture system utilizing redox-active species, it is important to prevent catalysis of CO₂ reduction by the metal center. Side reactions involving CO₂ reduction can lead to a decrease in system efficiency by converting a portion of CO₂ to the reduced products such as CO. The resulting impure product stream in such cases would hamper subsequent utilization or sequestration of the captured CO₂. Additionally, potentially permanent CO poisoning on the metal center can result in a reduced effective concentration of the redox-active compound in the solution which can negatively impact carbon capture capacity, cyclability, and the overall lifetime of the system. In the system utilizing Fe-EDDHA, which exposes open coordination sites upon reduction as proposed, there is a significant risk of CO₂ reduction facilitated by CO₂ binding at these open coordination sites. To prevent this undesired electron transfer pathway, a metal center guardian was introduced, rather than relying on the prevalent redox potential shifting method. Pyridine-3-carboxylic acid amide (or nicotinamide, NA) was chosen, as pyridine, despite being neutral, causes moderately large d-orbital splitting leading to strong bonding interaction to metal centers. This addition effectively disables CO₂ reduction catalysis by sterically obstructing the approach of CO₂ to the iron center.

This distinctive metal center guardian approach to mitigate undesired electron transfers at the molecular level, in accordance with certain embodiments, distinguishes this work from potential-shifting methods and can extend its applicability to achieving system stability beyond CO₂ reduction, including stability towards oxygen. An important distinction lies in the high electron density at the metal center of coordination complexes that is effectively shielded by ligands, affording the opportunity to employ suitable metal center guardians as sentinels against undesired electron transfers. In stark contrast, conjugated organic compounds like quinone and phenazine compounds have electron distribution across their conjugated structure and expose their entire aromatic structures to potential electronic interactions when encountering counterpart species, making them susceptible to electron transfer. While the system in this disclosure successfully demonstrates the desired metal center guarding effect under the current conditions, it is important to note that outer-sphere electron transfer, which cannot be kinetically blocked, may still occur and can often be faster than inner-sphere processes.

The present strategy offers fundamentally distinct advantages over strategies that employ stabilizing oxygen. The reduction potentials for the closed species (2c and 3c), which determine the potential required for the electrochemical reduction step in three-stage and four-stage systems and influence other performance metrics such as CO₂ capture kinetics and the amount of CO₂ separated per each electrochemical swing, remain consistent in the presence and absence of NA. The electron transfer pathway is sterically blocked (kinetic control via steric hindrance) by the introduction of a metal center guardian to block undesired electron transfer to oxygen. In contrast, potential shifting methods (thermodynamic control) typically alter the reduction potential to avoid undesired electron transfers to oxygen, which can negatively impact CO₂ capture kinetics and the amount of CO₂ separated per each electrochemical swing. Although the potential of the open forms (2o and 3o) may shift with different metal center guardians, this primarily affects the electrochemical oxidation steps and is less of a concern for oxygen reduction reactions.

### Results and Discussion

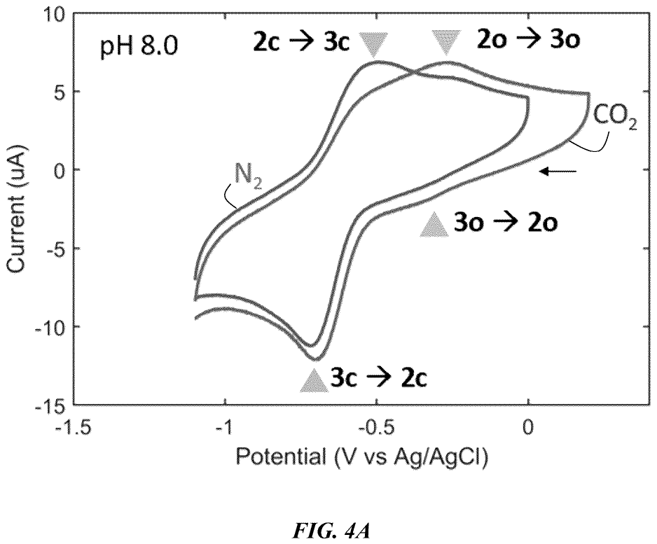

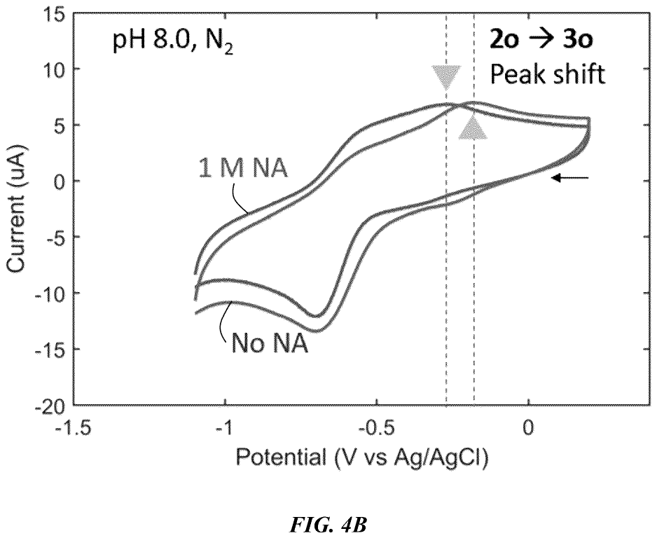

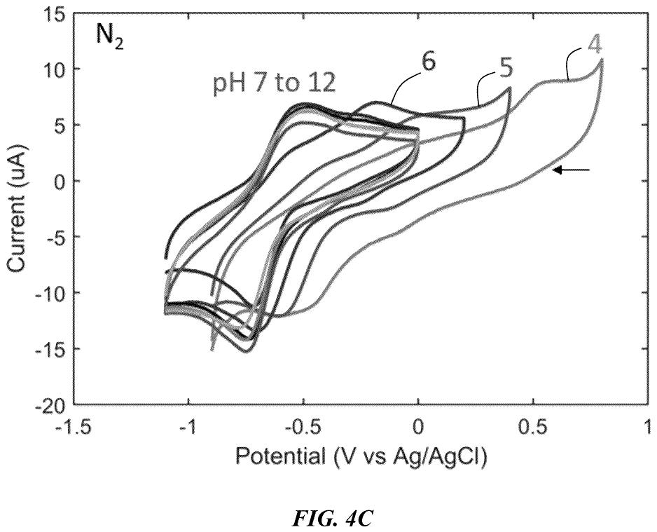

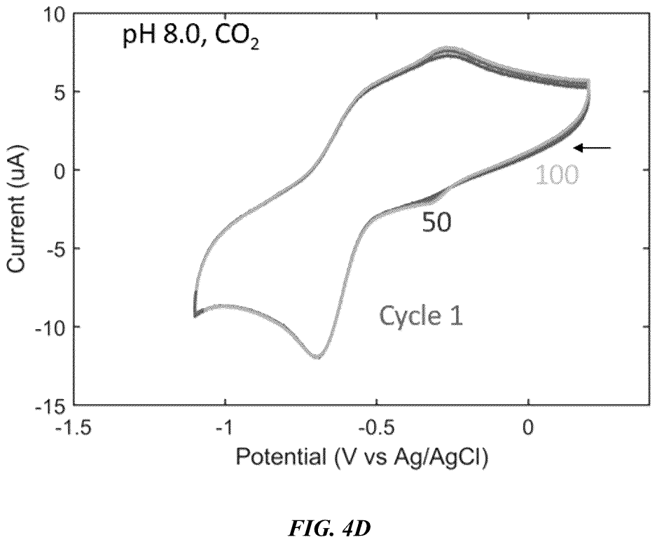

A series of cyclic voltammetry (CV) experiments were conducted to investigate the electrochemical behavior of the Fe-EDDHA system. In FIG. 4A, CV measurements are shown for the system under nitrogen (N₂) and CO₂ at pH 8 in an aqueous solution with 0.1 M of potassium nitrate (KNO₃) as a supporting electrolyte and 1 M of NA as an iron center guardian. Under N₂, Fe-EDDHA shows a reduction peak at −0.72 V and a quasi-reversible oxidation peak at −0.50 V vs Ag/AgCl with another minor set of redox peaks at −0.35 V for reduction and −0.25 V for oxidation, attributed to phenolate ligands in the open conformation. Under CO₂, a larger oxidation peak of the 20 was observed at −0.25 V, accompanied by a smaller oxidation peak corresponding to the closed form at −0.50 V. These results suggest an equilibrium between the 2c and 20 forms, which can be influenced by the presence of CO₂. Notably, regardless of the presence of CO₂, the electrochemical reduction behavior exhibited a similar shape in the reductive scan (lower region of the curves) under both N₂ and CO₂ atmospheres. These findings indicate that the equilibrium between 3c and 3o strongly favors the closed form (3c) and is not significantly disrupted by the presence of CO₂.

CV curves acquired for the Fe-EDDHA solution both with and without the presence of NA, an iron center guardian, are shown in FIG. 4B. The curves displayed similar major peak potentials, indicating consistent electrochemical behavior of Fe-EDDHA-closed forms (3c and 2c) regardless of the presence of NA in the aqueous solution. It is important to highlight the minor shift observed in the oxidative peak potential of 2o from −0.33 V to −0.25 V in the presence of NA, which suggests that NA stabilizes 2o by coordinating to the iron center, leading to a positive shift in the oxidation peak within the CV curve. This observation corroborates the hypothesis regarding the blocking of the iron center by NA when 2o is generated by electrochemical reduction.

In FIG. 4C, a series of CV experiments under various pH conditions are shown. Notably, substantially identical curves were obtained within the pH range of 7 to 12. Without wishing to be bound by any particular theory, it is believed that the consistent peak positions across these pH values indicate that the electron transfer process does not involve proton transfer. Notably, at pH values lower than 6, a significant effect of pH on the CV curves was observed. Specifically, a larger oxidation peak for the open forms (2o to 3o) was observed, and the peak shifted towards more positive potentials. These findings suggest that above a certain concentration of protons, the equilibrium between 2c and 2o can be shifted towards the 2o through the protonation of the phenolate oxygen. The observed slight shifts in the reduction peak also indicate that the reduction of 3c and 3o is influenced by proton concentration at pH values lower than 6.

Interestingly, the CV curve obtained under CO₂ at pH 8 (FIG. 4A) aligns with the CV curve acquired under N₂ at pH 6 (FIG. 4C), i.e., the electrochemical behavior of Fe(II)-EDDHA in the CO₂-saturated solution at pH 8 resembles that observed in the pH 6 solution under N₂. It is believed that this similarity can be attributed to the equilibrium shift towards 2o induced by the presence of CO₂. As is evident in FIG. 4D, multiple CV measurements conducted over 100 cycles under CO₂ provide evidence of the chemical stability of the hemi-labile iron species under the given conditions.

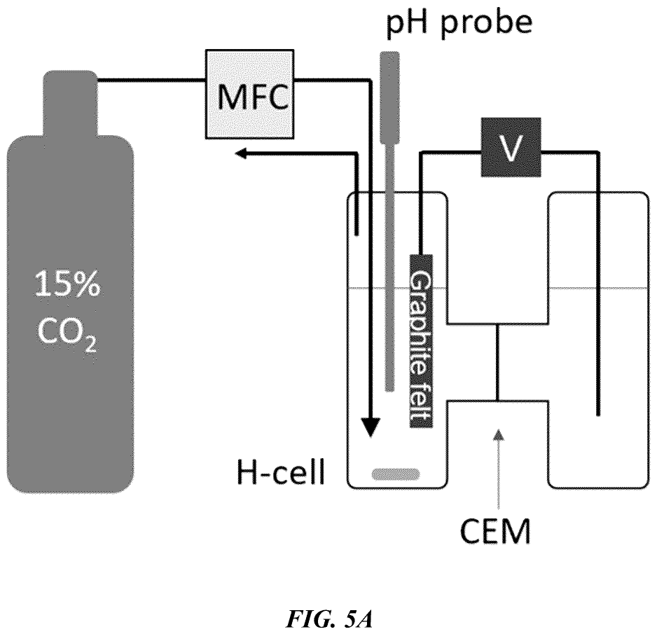

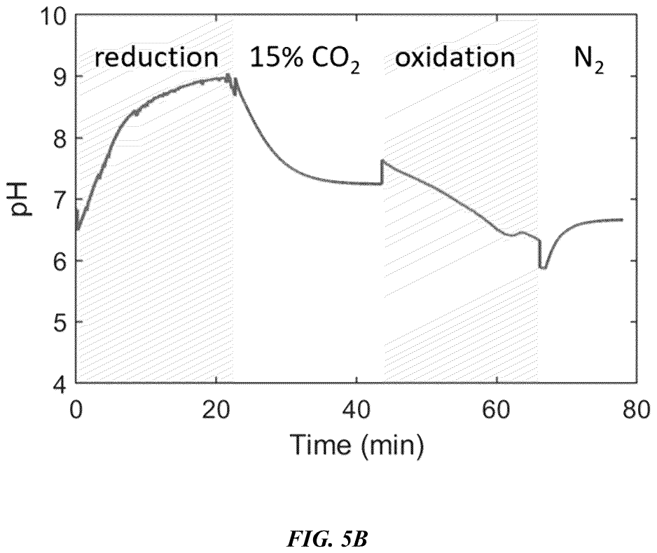

A bench-scale setup using an electrochemical H-cell was constructed for CO₂ capture and release in the Fe-EDDHA redox system. A schematic of the system is shown in FIG. 5A. The system was equipped with a cation exchange membrane (CEM) separating two 5 mL reaction chambers, graphite felt as a working electrode, and a stainless-steel wire electrode for an arbitrary reaction in the counter chamber. The 4 mL reaction mixture containing 50 mM Fe(III)EDDHA (200 mmol) in water in the presence of 1 M NA as an iron center guardian and 1 M KNO₃ as a supporting electrolyte saturated with 15% CO₂ was reduced electrochemically in a constant current mode at 10 mA for 22.5 min (equivalent to 140 mmol of electrons transferred) to yield 70% reduction of the Fe(III)EDDHA to Fe(II)EDDHA. Then a 15% CO₂ gas stream was introduced for 20 min at a flow rate of 30 mL/min to re-saturate the solution, followed by anodic oxidation. The pH of the solution was monitored continuously by a pH probe throughout the CO₂ capture and release steps (see FIG. 5B). During the reduction process, the pH increased from 6.8 to 9.0, which is consistent with the weak basicity of the phenolate moiety in 2o (pKa₁: 5.56, pKa₂: 9.43 obtained by titration; EDDHA pKa₁: 10.2, pKa₂: 11.744). Upon introducing the 15% CO₂ gas stream, the solution reached a steady-state pH of 7.3 after 20 minutes. During the subsequent anodic oxidation process, the pH decreased to 6.6 to complete the cycle.

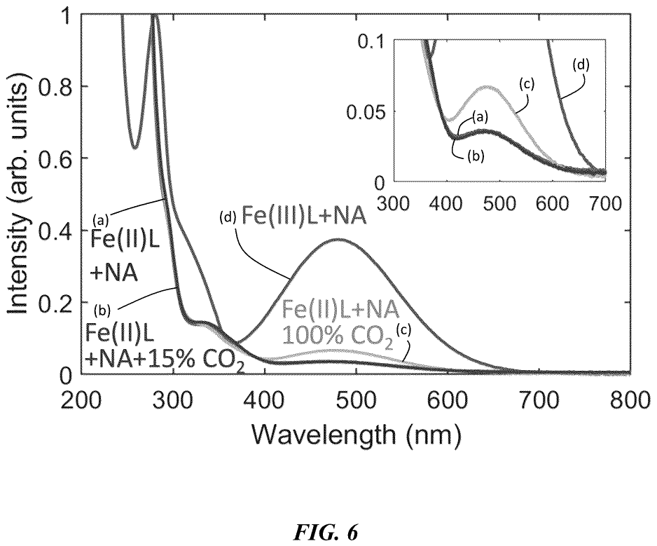

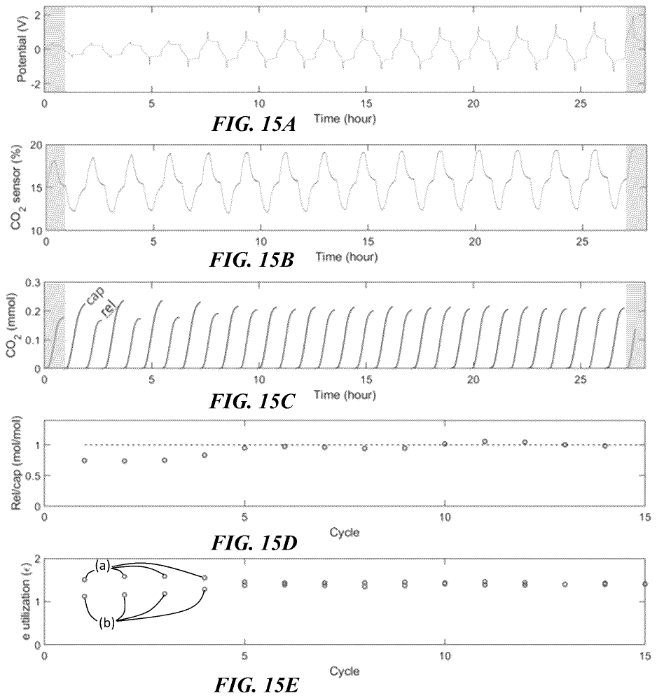

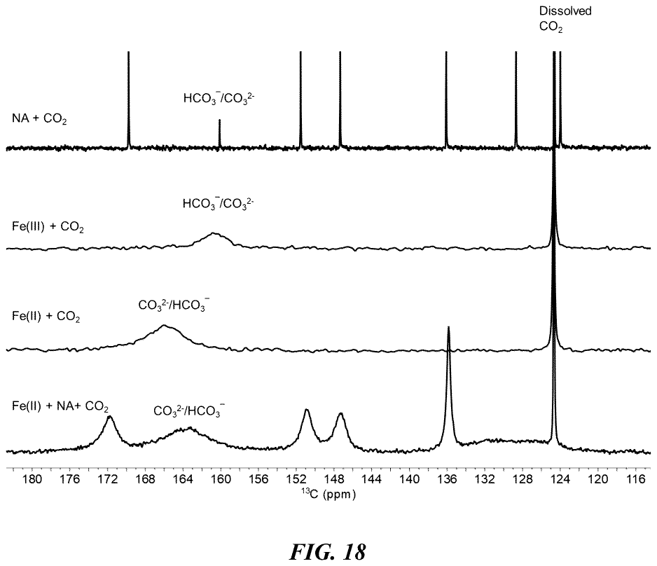

The stability of the Fe(II)-EDDHA solution under a 15% CO₂ atmosphere was assessed via UV-vis absorption spectroscopy (FIG. 6). The 45 mM Fe(II)-EDDHA solutions prepared by electrochemical reduction in the presence of 1 M NA and 1 M KNO₃ in water were subjected to bubbling with 15% CO₂ and 100% CO₂ at flow rates of 10 mL/min for 20 min. The freshly prepared Fe(III)EDDHA solution showed one absorption peak at 481 nm with an intensity of 0.374; this peak intensity decreased to 0.034 after 90% reduction, and remained at this value for 20 min when contacted with 15% CO₂. In contrast, contact with 100% CO₂ led to a partial recovery of the peak intensity to 0.066 observed for Fe(III)EDDHA, suggesting Fe(II) oxidation to Fe(III) concurrent with CO₂ reduction under a 100% CO₂ atmosphere. In a set of control experiments, it was observed that 60% of the Fe(III)-EDDHA peak was recovered on the introduction of 15% CO₂ for 20 min in the absence of NA, an iron center guardian (See FIG. 18). This result supports the supposition that NA plays an essential role as an iron center guardian to avoid CO₂ reduction via inner-sphere electron transfer by Fe(II)-EDDHA. While outer-sphere electron transfer, which cannot be kinetically blocked, may still occur and can be faster than inner-sphere processes, the desired metal center guarding effect has been clearly demonstrated under the current experimental conditions. Introduction of air for 20 min into the Fe(II)-EDDHA solution yielded 94% recovery of the UV-vis peak at 481 nm, indicating Fe(II)-EDDHA is rapidly oxidized back to Fe(III)-EDDHA when in contact with oxygen (See FIGS. 15A-15E). While the addition of NA effectively blocks electron transfer to CO₂, its protective effect against O₂-induced oxidation appears limited under the current conditions.

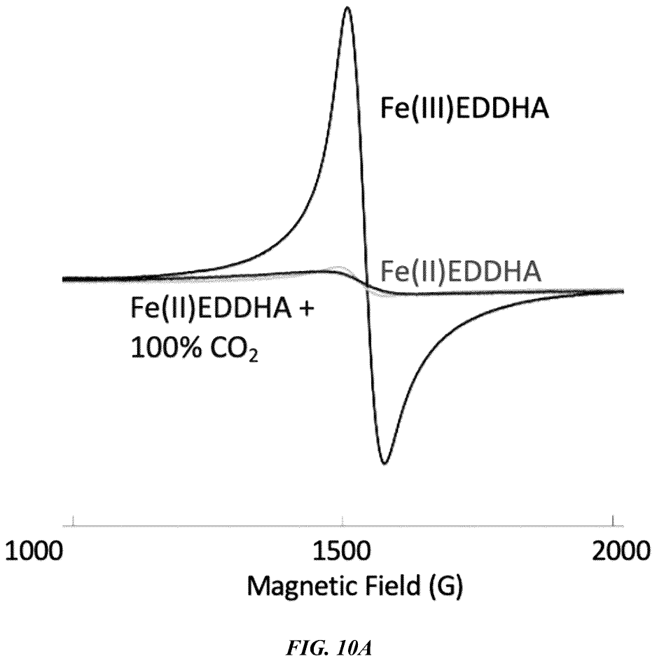

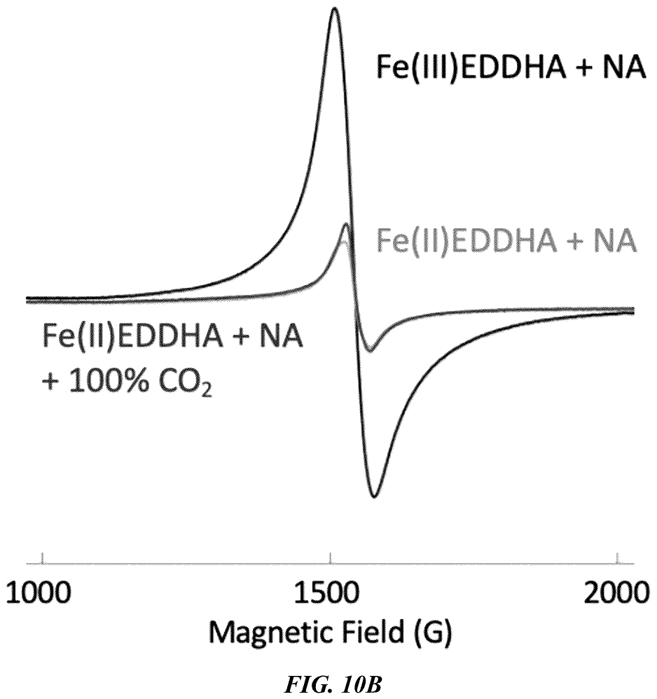

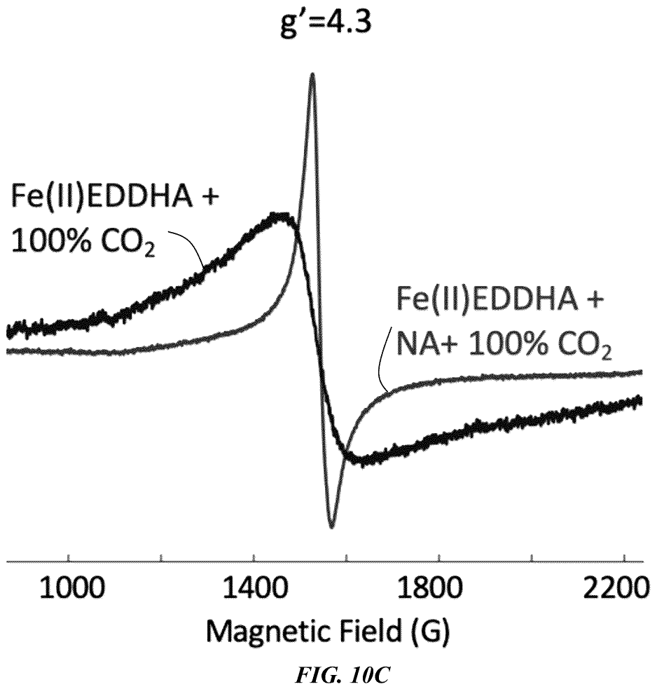

Electron paramagnetic resonance (EPR) spectroscopy was employed to gain deeper insights into the role of NA, as illustrated in the FIGS. 10A-10C. Compared to the pristine solution of Fe(III)EDDHA with 47±3 mM Fe(III) estimated from the EPR signal at g′=4.3, 9.1±0.6 mM Fe(III), 20% of Fe(III) signal at g′=4.3 is detected after electrochemical experiments, confirming that 80% of Fe(III) is reduced to Fe(II) (FIG. 10A). After 100% CO₂ is bubbled into the Fe(II)EDDHA solutions for 5 minutes, the Fe(III) signal increases by 1.2-fold in the presence of NA 11.2±0.7 mM (FIG. 10A) and 1.5-fold increase in the absence of NA 13.5±0.8 mM (FIG. 10A), which is consistent with the UV-vis observations in FIG. 6. More importantly, in the absence of NA, the EPR signal (FIG. 10C) becomes significantly broader upon CO₂ introduction, indicating that CO₂ can cause a significant change in the Fe(III) coordination structure and symmetry. In contrast, in the presence of NA, the EPR signal retained its original line shape (FIG. 10B), indicating that NA effectively prevents these structural changes, once again highlighting NA's role as an iron center guardian from CO₂.

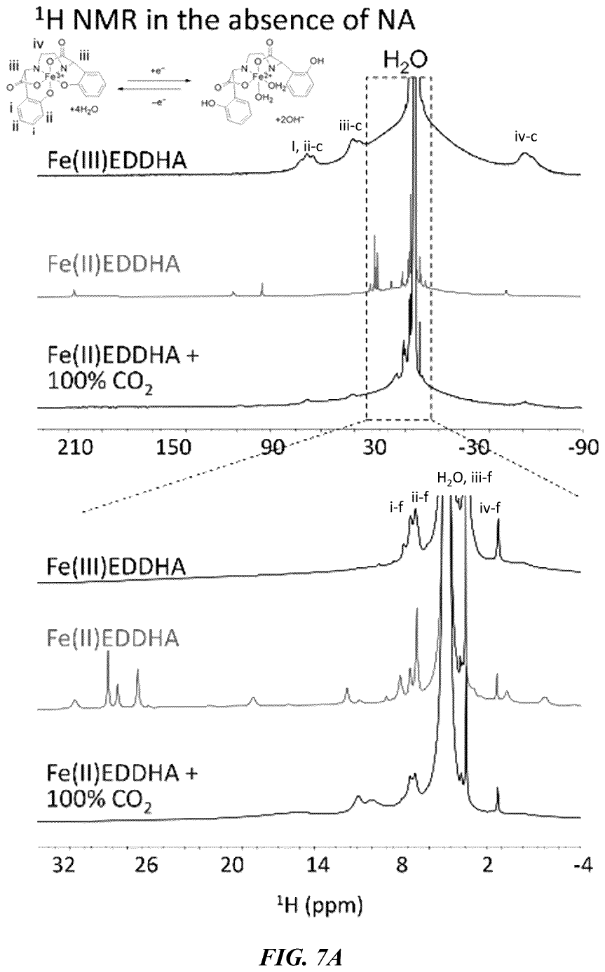

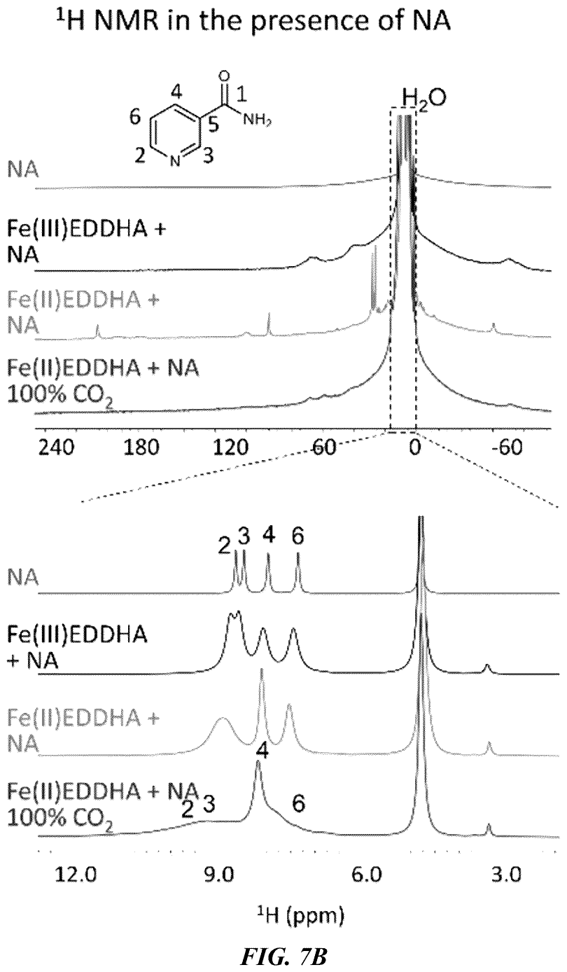

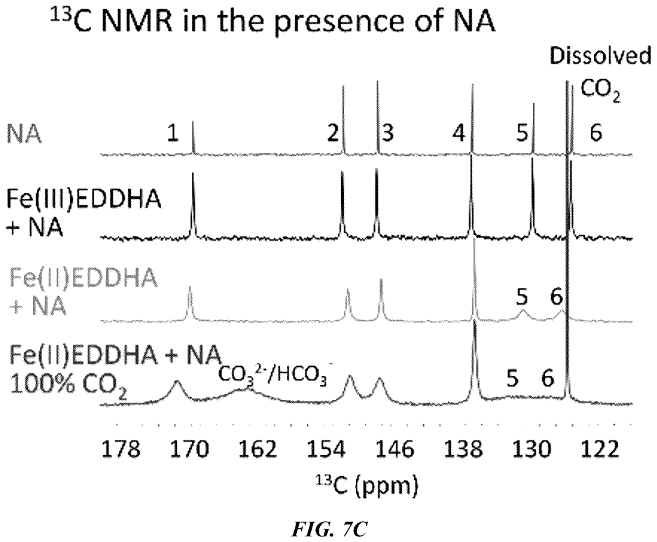

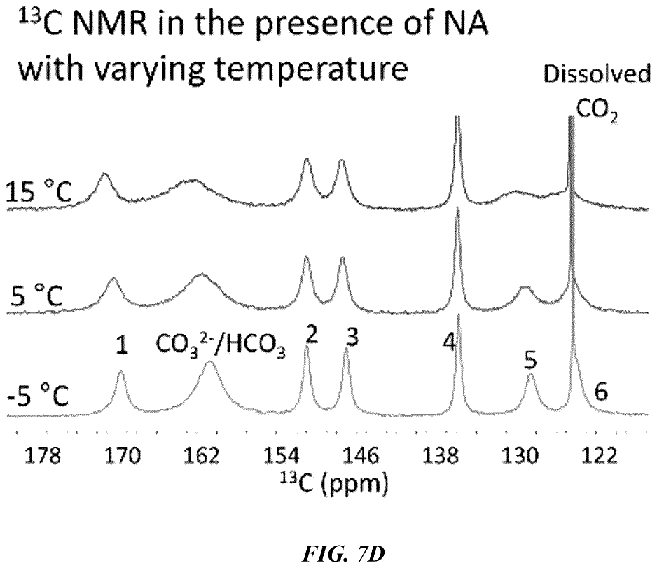

Solution-state ¹H and ¹³C NMR were performed on a series of solutions to further understand the structural changes in Fe-EDDHA following electrochemical reduction, and elucidate the interactions between NA, CO₂, and the iron center at the molecular level. In the pristine Fe(III)EDDHA solution, three sets of broad proton signals in the range of 75-60 ppm, 45-33 ppm, and −54-−70 ppm are observed and tentatively assigned to the aromatic protons, N—CH—COO, and CH₂ protons of the EDDHA molecules coordinating to Fe(III) (FIG. 7A). Some relatively sharp signals between 0 and 10 ppm can be explained by the existence of free, non-coordinating EDDHA and of impurities in the solution. Reduction of Fe(III) to Fe(II) completely replaces these three sets of broad signals with sharp signals located at 210-170 ppm, 120-90 ppm, 30-10 ppm, and −50 ppm (FIG. 7A). It is believed that the dramatic difference in the 1H NMR spectra of Fe(III)EDDHA and Fe(II)EDDHA indicates the change in the coordination configurations of EDDHA with the Fe(III) and Fe(II) centers, and is consistent with the transition from Fe(III)EDDHA-closed (3c) to Fe(II)EDDHA-open (2o) upon electrochemical reduction. When CO₂ was introduced to the solution, most of the sharp proton signals disappeared, and the remaining broad signals were indicative of EDDHA exchanging between Fe(II) and Fe(III) open and closed forms. Addition of 1 M NA did not significantly alter the changes in EDDHA signals in the ¹H NMR spectra (FIG. 7B). However, the substantial broadening of H2, H3 and H6 signals of NA in the presence of Fe(II), especially when CO₂ is introduced, strongly suggests the interaction between NA and Fe(II) center.

The ¹³C spectra of NA also confirm this interaction between NA and Fe(II)EDDHA (FIG. 7C). While the paramagnetic Fe(III) only slightly and homogeneously broadens all ¹³C signals, the diamagnetic Fe(II) shifts C5 and C6 to higher frequency by 1 ppm with even broader broadening. Introduction of CO₂ to the Fe(II) solution further pronouncedly broadens all ¹³C signals, especially C5 and C6, and also shifts C1 to higher frequency by 1.8 ppm. These observations suggest that the entire conjugated R electron system involving the pyridine ring and the amide group coordinates to Fe(II); C5 and C6 experience the most broadening because they have the highest electron density on the pyridine ring and therefore are influenced the most by coordinating to the iron center.

The ¹³C NMR spectra of Fe(II)EDDHA in the presence of 1 M NA under the CO₂ atmosphere, collected across a temperature range from 25° C. to −5° C. (FIG. 7C bottom, FIG. 7D), show that all ¹³C signals except for the dissolved CO₂ signal, sharpen as the temperature decreases. While NMR signals typically broaden at lower temperatures due to reduced molecular mobility, in systems with chemical exchange between different magnetic environments, the spectra are significantly affected by exchange rates, chemical shift differences, and the fraction of molecules in each environment.

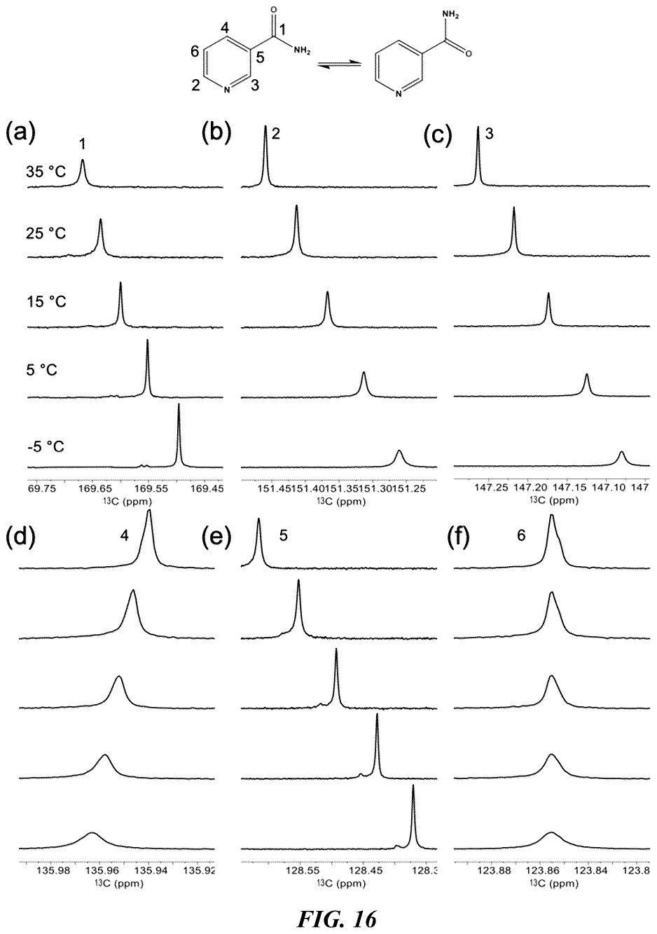

In the case of two-site exchange, NMR spectra exhibit a typical pattern of line broadening to a coalescence point followed by the sharpening and appearance of a second set of signals, as the temperature lowers and the chemical exchange slows down. For instance, ¹³C spectra of 1 M NA in D₂O exhibit broadening of C2, C3, C4, and C6, while C1 and C5 signals sharpen with the appearance of new signals at higher frequencies as temperature decreases (See FIG. 16). These changes are consistent with the chemical exchange between the different NA conformers observed in the crystal structures.

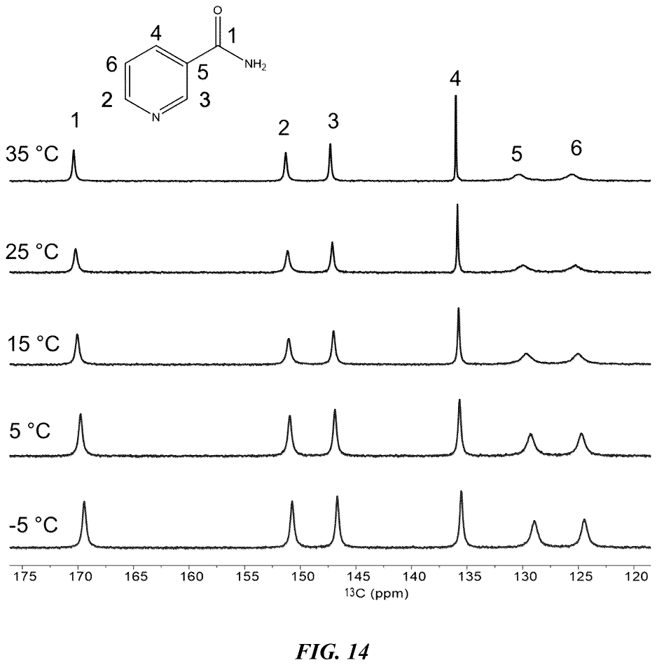

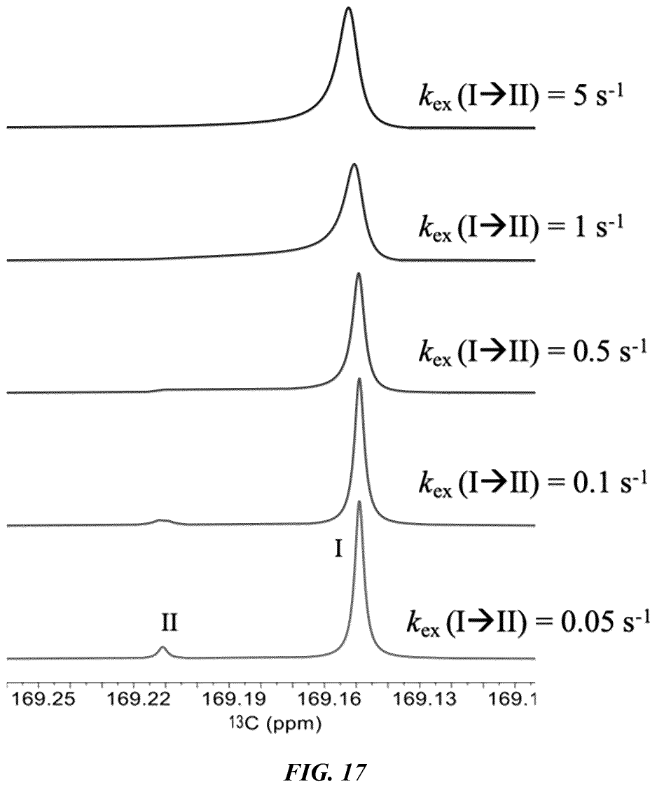

A set of simulated spectra with the two-site exchange rates varying from 5⁻¹ to 0.05 s⁻¹ (See FIG. 17) captures several features observed in the spectral changes shown in FIG. 16. Similar to FIG. 16 subpanel (a), it is believed that the sharpening of ¹³C signals at lower temperatures in FIG. 7D is a result of chemical exchange, between free NA and NA coordinating to Fe(II), with the free NA signals dominating at lower temperatures and the bound NA being undetectable even with a spectral width of 6000 ppm, indicating that the bound NA signals are too broad or beyond the detection limits of NMR. A similar sharpening pattern is observed in the ¹³C signals of C5 and C6 of Fe(II)-EDDHA and 1 M NA solution (in the absence of CO₂) as temperature decreases (See FIG. 14). Although the exchange rates were not precisely calculated, the clear two-site exchange pattern suggests that the lifetime of bound NA lies within the millisecond-to-second range between 25 and −5° C.

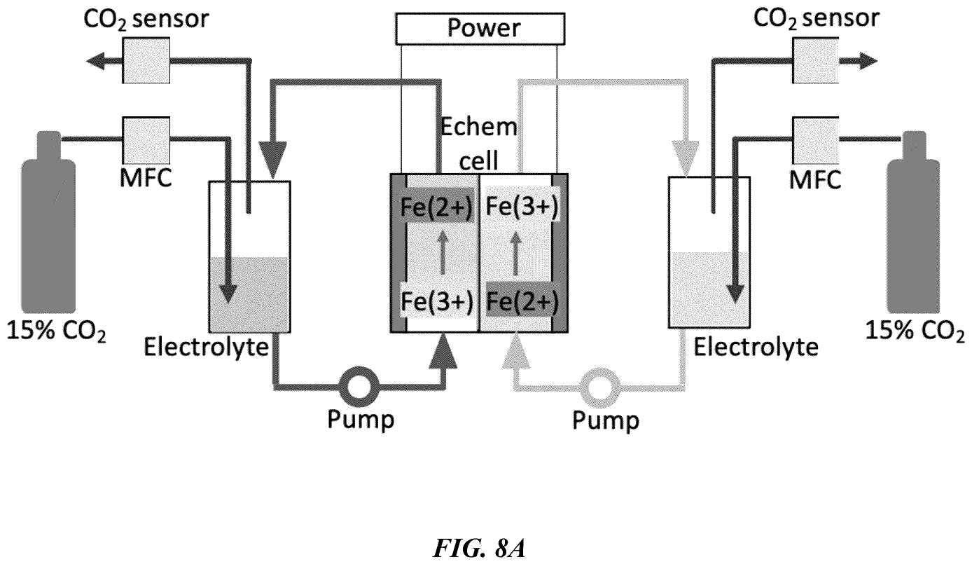

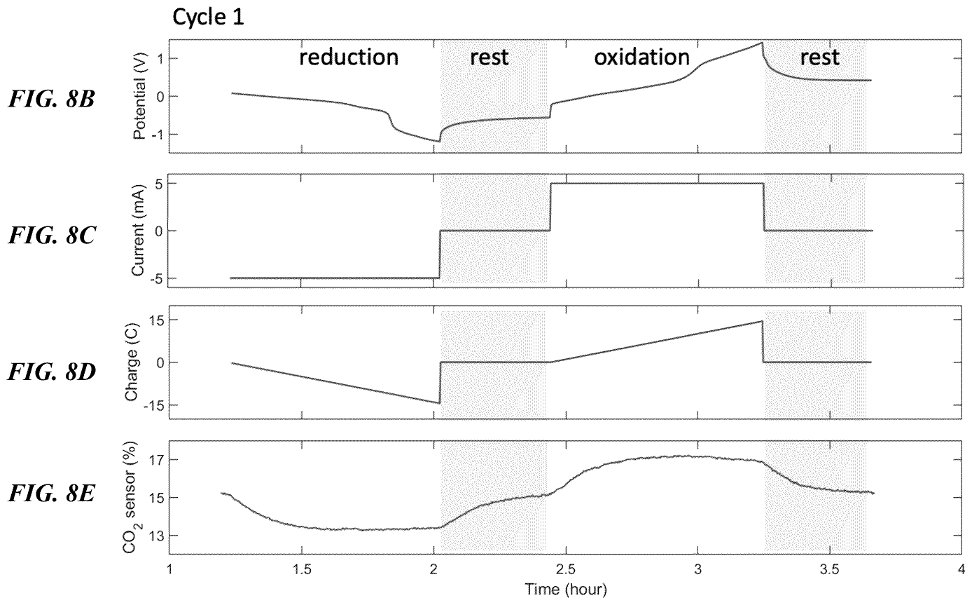

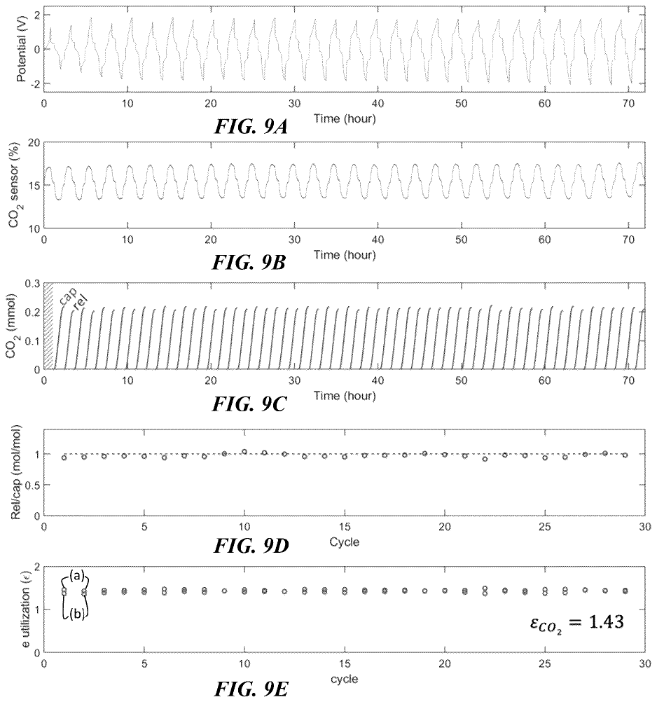

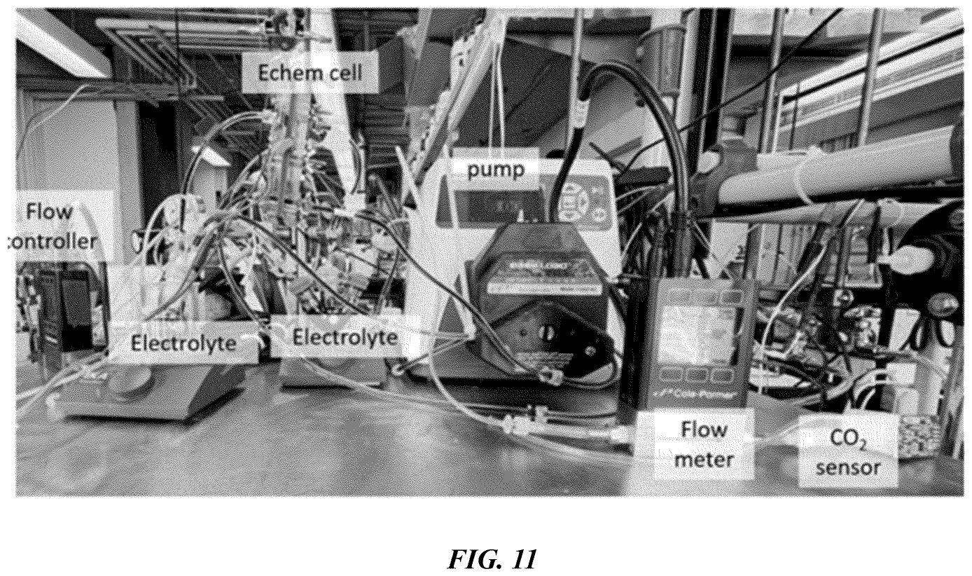

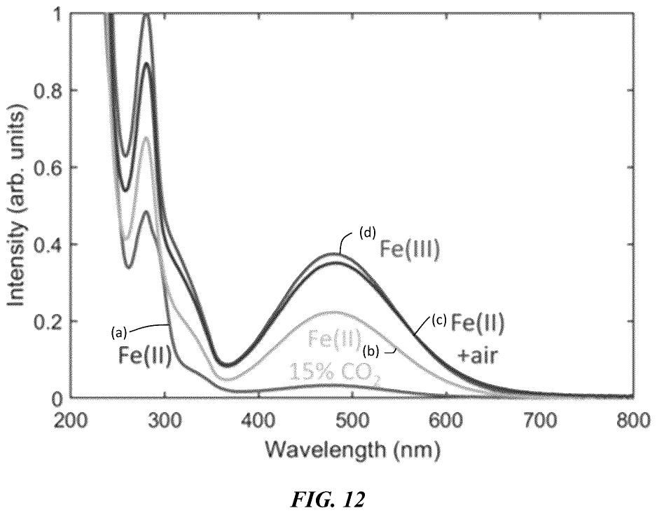

A symmetric cyclic system was constructed to process a 50 mM Fe-EDDHA solution in the presence of 1 M NA and 1 M KNO₃ as a supporting electrolyte in water. A schematic of the flow cell is shown in FIG. 8A. (See Supporting Section 3 for detailed setup information and FIG. 11 for a visual representation of the setup). The flow cell structure included graphite-felt electrodes in both chambers and a cation exchange membrane that divided the cell into the cathodic and anodic chambers and allowed for the pH difference between them to be maintained. The system was equipped with two reservoirs, one for catholyte and one for anolyte, which were alternated by cycling. Both chambers were equipped with 15% CO₂ inlet and outlet streams with output gas concentration determined by a CO₂ sensor. 50% of the capacity of the system was utilized to minimize undesired side reactions under the constant current mode of operation at 5 mA with 15% CO₂ at a flow rate of 5.3 mL/min. The first cycle of the system is illustrated in FIGS. 8B-8E. During this cycle, the cell potential was recorded as in FIG. 8B under the application of negative and positive 5 mA currents (FIG. 8C). When a negative potential was applied, the working electrode side of the cell performed reduction of the Fe(III)-EDDHA resulting in the alkalization of the aqueous solution and the capture of CO₂, indicated by the decrease in the CO₂ percentage of the output stream (FIG. 8E). On the counter electrode side, oxidation of Fe(II)-EDDHA occurred, releasing CO₂. Conversely, when a positive potential was applied, the working electrode side performed oxidation of the Fe(II)-EDDHA solution, causing the solution to become acidic and release CO₂, as indicated by the increased CO₂ percentage of the output gas stream (FIG. 8E). The achieved operational energy consumption was determined to be 22.6 kJₑ/mol of CO₂, with an average electron utilization of 1.43.

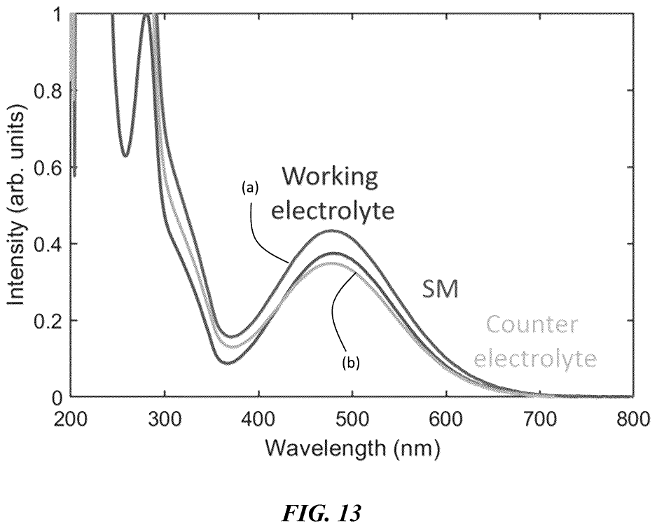

The cyclic experiments conducted over 29 cycles at a constant current mode of 5 mA are described in FIGS. 9A-9E. An average electron utilization of 1.43 was achieved over 29 cycles, along with 0.94 V of average voltage, resulting in an operational energy of 63.7±1.0 kJₑ/mol. These cyclic experiments provided robust support for the electron-leveraging strategy, as they demonstrate electron utilization values exceeding unity, thereby reducing operational energy consumption with a 15% CO₂ feed. The ratio between the released CO₂ amount and the captured amount of 1 was maintained over multiple cycles (FIG. 9D), indicating that the reversible capture and release of CO₂ occurred without side reactions such as CO₂ reduction. Following the cyclic experiments, UV-vis measurements of the solutions confirmed the stability of the Fe-EDDHA species without significant decrease in concentrations (See FIG. 13). However, it should be noted that the system displayed sensitivity to oxygen, presumably leading to cell voltage increases between cycles. Additional cyclic experiments for 14 cycles (See FIGS. 15A-15E) with assembly of cell components in a glovebox for extensive air removal presented stable and reversible CO₂ capture and release with an electron utilization value of 1.40, at decreased cell voltage average of 0.39 V, corresponding to 23.9 kJₑ/mol of energy requirement. Inter-cyclic potential increases suggest potential air contact during circulation of solutions through multiple cycles.

The cyclic experiments presented in this example are conceptual demonstrations aimed at assessing the stability and cyclability of the system during repeated redox cycles. The energy calculations derived from these experiments provide insight into the electrochemical energy consumed per mole of CO₂ separated under the specific experimental conditions and should be interpreted as conceptual estimates. The experimental setup described in this example, which flows 15% CO₂ through both the anolyte and catholyte, does not necessarily represent the conditions necessary for producing a pure CO₂ stream. Furthermore, these energy estimates may be underestimated due to the low separation extent observed in the cyclic system under the current experimental conditions.

### CONCLUSION

In conclusion, this disclosure introduces the use of hemi-labile ligands, which exhibit unique coordination behaviors dependent on the oxidation state of the metal center, thereby broadening and enhancing the applicability of an electron-leveraging strategy. This approach expands the potential for optimization and increases efficiency in electrochemical carbon-capture systems. This strategy was demonstrated by employing Fe-EDDHA with dissociation of two phenolates upon a one-electron reduction at the metal center. The introduction of NA as an iron center guardian effectively prevented CO₂ reduction at the metal center, ensuring system reversibility, efficiency and stability. The proposed mechanism of electron leveraging and metal center blocking at the molecular level is supported by a combination of UV-vis, NMR, and EPR analyses. The robustness, stability, and reversibility of the cyclic electrochemical cell operation using homogeneous aqueous solutions and a 15% CO₂ feed was demonstrated. The minimum operational energy consumption achieved using a proof-of-concept cyclic experiment was 22.6 kJₑ/mol of CO₂, with an average of 63.7±1.0 kJₑ/mol for 29 cycles, utilizing an average electron utilization value of 1.43, exceeding the previous theoretical limit of 1.

Furthermore, it is anticipated that the present work will stimulate further exploration of this electron-leveraging strategy by utilization of reversible hemi-labile coordination complexes as redox-active materials in electrochemical carbon capture. This exploration may extend beyond the current 2× leveraged system to more advanced 3× or even 4× leveraged systems. In addition, the redox center blocking strategy holds potential for efficiently achieving redox-active material stability from undesired electron transfer reactions under various operational conditions, particularly in the presence of oxygen. These research endeavors aim to achieve a more substantial reduction in energy consumption and establish electrochemical carbon-capture processes that are robust, efficient, durable, and scalable towards a more sustainable future.

### Supporting Information

### 1.1 Material

Commercially available chemicals were purchased from Sigma-Aldrich Chemical Company (Milwaukee, WI) and were used as received. Fe-EDDHA was purchased from Grow More (Gardena, CA). Ag/AgCl reference electrodes were purchased through BASi (West Lafayette, IN). CO₂ cylinders (1, 4, 15, and 100% balanced by nitrogen) were purchased from Airgas (Radnor Township, PA). Purified water was obtained using Milli-Q Direct Water Purification System.

### 1.2 Purification of Commercial Fe-EDDHA

Commercial Fe-EDDHA was obtained and subjected to purification. Commercial Fe-EDDHA fertilizer may contain sodium and potassium salts. To begin, an excess amount of commercial Fe-EDDHA was dissolved in methanol and subsequently filtered. The filtrate obtained was then dried using a rotary evaporator. This procedure was repeated once more to ensure the removal of any residual inorganic particulate matter. The resulting solid was then washed with dichloromethane to eliminate any organic contaminants. The filtrate was subsequently dried, leading to the commencement of recrystallization as the methanol and dichloromethane evaporated. Upon completion, shiny glassy black needles were obtained after drying. The purity of the purified Fe-EDDHA was confirmed by UV-vis spectroscopy each time a new batch was prepared. The purity of the commercial Fe-EDDHA was determined to be 72%.

### 1.3 Electrochemical Method to Determine Crystal Purity

An electrochemical method was used to determine crystal purity. This method relied on the assumption of near-unity faradaic efficiency.

The procedure was as follows:
(1) Dissolve 0.2 mmol of the impure Fe-EDDHA sample in 4 mL of aqueous electrolyte to prepare a 50 mM solution, potentially containing sodium and potassium salts (Sample 1).
(2) Conduct electrochemical reduction on Sample 1 for 50% reduction by applying −10 mA for 965 seconds, delivering 0.10 mmol of electrons (Sample 2). This follows the standard procedure for the electrochemical reduction of Fe(III)EDDHA.
(3) Measure the UV-Vis spectra of Sample 1 and Sample 2 after diluting them to 125 μM. Record the peak intensities at 481 nm (I1 for Sample 1 and 12 for Sample 2).
(4) Calculate the difference in peak intensity at 481 nm after the 50% reduction (I50,red=I1−I2)
(5) Prepare a purified Fe-EDDHA sample (Sample 3) and measure its UV-Vis peak intensity at 481 nm (I3).
(6) Determine the purity of the impure sample using the formula:

$$Purity ( \% ) = I\_ 3 / ( I\_ ( 50 , red ) \times 2 ) \times 100$$

I1: 0.2784 at 481 nm
I2: 0.0928 at 481 nm
I50,red=0.1856
I3=0.3747 at 481 nm

The calculated purity using the electrochemical method was 100.9%.

### 1.4 Instrumentation

Proton nuclear magnetic resonance (¹H NMR) spectra were obtained on a Bruker 400 MHz NMR instrument (400 MHz). Chemical shifts for proton and carbon are reported in parts per million (ppm). The following designations are used to describe multiplicities: s (singlet), d (doublet), t (triplet), q (quartet), m (multiplet), br (broad). The mass flow controller (GFCS-014657) and flow meter (GFMS-015835) were purchased from Aalborg Instruments & Controls, INC (Orangeburg, NY) and Avantor Masterflex (Allentown, PA) and were calibrated for CO₂ by the vendor before use. The CO₂ FT-IR sensor (GC-0016 for 0-100%, GC-0006 for 0-20% of CO₂) was purchased from CO2Meter (Ormond Beach, FL) and was calibrated for CO₂ before use. All cyclic voltammetry (CV) experiments were performed using PARSTAT MC (PMC-2000), from Ametek (Oak Ridge, TN). The UV-Vis Spectrophotometer (Cary 60) was purchased from Agilent (Santa Clara, CA). The pH was measured using a pH probe (Orion PerpHecT ROSS), which was calibrated prior to the experiment.

### 1.5 EPR and NMR

All solutions were prepared using D₂O (99.9 atom % D, Sigma Aldrich) for EPR and NMR measurements. The solutions with CO₂ were prepared inside the glove box immediately before EPR and NMR experiments. EPR measurements were performed on a Bruker ELEXSYS E580 spectrometer operated at X-band with a microwave frequency of 9.32 GHz. A capillary with ID 0.8 mm and OD 1.0 mm was used to hold the sample with both ends sealed inside a 4 mm EPR tube. The temperature was reduced gradually to 100 K (1-2 hours) using liquid N₂ tank to avoid the breaking of capillary tube.

¹H and ¹³C NMR measurements were performed on a Varian-DDR spectrometer and a Bruker Avance Neo spectrometer with an 11.7 T magnet. 900 pulse widths were 8.3 μs and 9.0 μs for ¹H and ¹³C respectively. For quantitative NMR analysis, a 30° pulse width was used with a relaxation delay of 10 s for ¹H and 300 s for ¹³C to ensure full equilibration between scans. For varying temperature experiments, each sample was equilibrated at the target temperature for 10 min before measurements. Both ¹H and ¹³C chemical shifts were referenced externally to Tetramethylsilane (TMS) at 0 ppm.

A calibration curve for iron was established by preparing a series of dilutions from an iron standard solution (10,000 μg/mL, Inorganic Ventures). Glycerol (38%) was employed as a cryoprotectant (glassing agent) during the cooling process to 125 K. The double integration of the resulting EPR spectra was used to determine the relationship between the EPR signal area and the iron concentration. This calibration curve was then utilized to estimate the concentration of Fe³⁺ in the samples.

### 2. Procedures for Electrochemical CO₂ Capture and Release

### 2.1 General Material Information for Electrochemical Reaction Setups in Batch

5 mL H-cell with #9 O-ring was purchased from Adams & Chittenden Scientific Glass Coop (Berkeley, CA).

Cation exchange membrane (FKS-30) was purchased from Fuel Cell Store (Bryan, Tx).

Graphite felt (G150 AvCarb© Soft Graphite Felt) was purchased from Fuel Cell Earth (Stoneham, MA).

### 2.2 Procedure for Electrochemical Reduction of Fe(III)EDDHA Solution in Batch

Reactions were carried out with graphite felt (0.5 cm×0.3 cm×2 cm was immersed in the solution) cathode and a stainless steel wire anode in 5 mL H-cell with #9 O-ring equipped with cation exchange membrane. In the cathodic chamber, Fe-EDDHA (87 mg, 0.2 mmol, 50 mM), nicotinamide (488 mg, 4 mmol, 1 M) and potassium nitrate (404 mg, 4 mmol, 1 M) were added into water (4.0 mL). In the anodic chamber equipped with a needle to prevent pressurization was placed potassium nitrate solution (404 mg, 4 mmol, 1 M, 4.0 mL of water). The solution was bubbled with nitrogen for 10 min, after which the electrochemical potential was applied at room temperature by a constant current of −10 mA for 1737 s (0.18 mmol of electrons) to provide 45 mM of Fe(II)EDDHA solution. The solution was monitored by pH meter.

### 2.3 Procedure for Electrochemical Oxidation of Fe(II)EDDHA Solution in Batch

Reactions were carried out with graphite felt (0.5 cm×0.3 cm×2 cm was immersed in the solution) anode and a stainless-steel wire cathode in 5 mL H-cell with #9 O-ring equipped with cation exchange membrane. In the anodic chamber, the Fe(II)EDDHA solution (45 mM, 4 mL) prepared as above was bubbled by 15% CO₂ for 20 min at a flow rate of 20 mL/min. In the cathodic chamber equipped with a needle to prevent pressurization was placed potassium nitrate solution (404 mg, 4 mmol, 1 M, 4.0 mL of water). The electrochemical potential was applied at room temperature by a constant current of 10 mA for 1737 s (0.18 mmol of electrons). The solution was monitored by pH meter and the gas output from the anodic chamber was measured by a flow meter and FT-IR CO₂ sensor.

### 2.4 Procedure for Stability Test Using UV-Vis Absorption Spectroscopy

Procedure for reduction of Fe(III)EDDHA was followed with an electrochemical potential of constant current of −10 mA for 1737 s (0.18 mmol of electrons) to provide 45 mM Fe(II)EDDHA solution. A set of 1 mL of solution in an 8 mL vial was prepared and contacted with 15% CO₂ (flow rate of 10 mL/min), and pure CO₂ (flow rate of 10 mL/min) for 20 min. The samples were measured by UV-vis. Each time 25 μL of the samples were collected and diluted with 10 mL water to provide 125 μM solutions that were measured by UV-vis absorption spectroscopy.

### 2.5 Procedure for Stability Test Using ¹H-NMR Spectroscopy

Procedure for reduction of Fe(III)EDDHA was followed with an electrochemical potential of constant current of −10 mA for 1930 s (0.20 mmol of electrons) to provide 50 mM Fe(II)EDDHA solution. A set of 1 mL of solution in an 8 mL vial was prepared and contacted with 15% CO₂ (flow rate of 10 mL/min), and pure CO₂ (flow rate of 10 mL/min) for 20 min. The samples were measured by ¹H-NMR. Each time, 0.5 mL of the samples were collected and added 50 μL deuterated water and the samples were measured by ¹H-NMR spectroscopy.

### 2.6 Procedures for Electrochemical Capture and Release of C02 in Continuous Flow

2.6.1 Procedure for Electrochemical Capture and Release of CO₂ in Cyclic Flow from 15% CO₂

The 6 mL of 50 mM Fe(III)EDDHA solution in 1 M KNO₃ and 1 M NA in water was added to a 10 mL three-neck round bottom flask anolyte reservoir equipped with a stir bar. The 6 mL of 1 M KNO₃ solution was added to a 10 mL round bottom flask catholyte reservoir equipped with a stir bar. Both catholyte and anolyte solutions were continuously bubbled by 15% CO₂ (balanced by nitrogen) at a flow rate of 5.3 mL/min.

The peristaltic pump equipped with Masterflex® 14 tubing was set to the liquid flow rate of 6 mL/min providing 22 sec of residence time in each 2.2 mL chamber of the flow cell. The electrochemical potential at a constant current mode of −10 mA for 2026 s (0.21 mmol of electrons) was applied to the cell to provide 35 mM of Fe(II)EDDHA with 15 mM of Fe(III)EDDHA (70% state of charge). The solution in the catholyte chamber was emptied and filled with 1.2 mL of 50 mM Fe(II)EDDHA and 4.8 mL of 50 mM Fe(III)EDDHA to provide 10 mM of Fe(II)EDDHA and 40 mM of Fe(III)EDDHA (20% state of charge). The electrochemical potential at a constant current mode of 5 mA for 2894 s (0.15 mmol of electrons) was applied to the cell followed by 1500 s of rest. Each cycle consisted of −5 mA for 2894 s, rest for 1500 s, 5 mA for 2894 s, and rest for 1500 s. The output gas flow was measured by a flow meter and CO₂ sensor for over 28 hours.

UV-vis absorption spectra were collected after 72 hours of operation under 15% CO₂ confirming stability of Fe-EDDHA under the current conditions.

### 3. Setup of Fe-EDDHA Redox System for the Electrochemical C02 Capture and Release

### 3.1 General Material Information for Electrochemical Reaction Setups in Cyclic Flow

Cation exchange membrane (FKS-30) was purchased from Fuel Cell Store (Bryan, Tx).

Graphite felt (G150 AvCarb® Soft Graphite Felt) was purchased from Fuel Cell Earth (Stoneham, MA).

Clear Scratch- and UV-Resistant Cast Acrylic Sheet (7/16) was purchased from McMaster-Carr (Aurora, OH).

Titanium foil, 0.025 mm (0.001 in) thick, 99.94% (metals basis) was purchased from Thermo Scientific (Waltham, MA).

Silicone rubber sheet 0.125 in thick was purchased from Rogers corporation (Chandler, AZ).

Peristaltic tubing (Masterflex Versilon Chemical (06475)-14) was purchased from Masterflex (Radnor, PA).

Tygon® tubing (ID 1/16 in, OD 3/16 in) was purchased from McMaster-Carr (Aurora, OH).

The peristaltic pump (Masterflex L/S) was purchased from Masterflex (Radnor, PA).

As shown in FIG. 8A and FIG. 11, a cyclic flow cell with graphite felt anode and cathode with a cation exchange membrane was connected to a potentiostat. The flow cell was connected to Tygon® tubing (ID 1/16 in, OD 3/16 in) at a liquid inlet (bottom) and outlet (top) of anodic and cathodic chambers (thru-hole 1/16 in). A peristaltic pump was used to deliver the electrolyte solution from the catholyte and anolyte reservoirs. The distal end of the tubing system from the cathodic chamber was connected to the catholyte reservoir and the tubing from the anodic chamber to the anolyte reservoir. The 15% CO₂ gas cylinder was connected to tubing and its stream was metered by a mass flow controller (MFC). The 15% CO₂ stream was introduced to the catholyte and anolyte solutions at a flow rate of 5.3 mL/min. An FT-IR CO₂ sensor and a flow meter were installed to monitor the output gas during cyclic flow operation from the headspace of catholyte and anolyte chambers.

### 4. Energy Calculation

The energy requirement using 15% CO₂ in cyclic flow is:
Average of cell potential under 15% CO₂ during operation for 29 cycles

$$( {E}_{cell , ave} ) = 0.9 \; 44 V$$

$${Energy}_{ave} = {E}_{cell , ave} \times 96.49 kJ / mol \cdot eV \times {( {ε}_{C O 2} )}^{- 1} = 63.7 {kJ}_{e} / mole of {CO}_{2}$$

where the average value of ε_{CO2} for electron utilization is 1.43 in cyclic flow for 29 cycles obtained in FIG. 9E.

The minimum energy requirement using 15% CO₂ during operation in cyclic flow is:

$$Cell potential under 15 \% {CO}_{2} for cycle 1 ( {E}_{cell , m i n} ) = 0.3 \; 35 V$$

$${Energy}_{m i n} = {E}_{cell , m i n} \times 96.49 kJ / mol \cdot eV \times {( {ε}_{C O 2} )}^{- 1} = 22.6 {kJ}_{e} / mole of {CO}_{2}$$

where the value of ε_{CO2} for electron utilization is 1.42 in cyclic flow for cycle 1 obtained in FIG. 9E.

U.S. Provisional Patent Application No. 63/214,845, filed on Jun. 25, 2021 is incorporated herein by reference in its entirety for all purposes. U.S. patent application Ser. No. 18/574,001, filed as a national stage entry of International Patent Application No. PCT/US2022/034818 having a filing date of Jun. 24, 2022, and published as U.S. Patent Application Publication No. US 2024/0307819 on Sep. 19, 2024, is incorporated herein by reference in its entirety for all purposes. U.S. Provisional Patent Application No. 63/769,696, filed on Mar. 10, 2025, and entitled “Leveraging Electrons for Electrochemical CO₂ Capture using a Hemi-Labile Iron Complex,” is incorporated herein by reference in its entirety for all purposes. H. Seo, Y. Chen, E. Walter, M. Abdinejad, and T. A. Hatton, “Leveraging Electrons for Electrochemical CO₂ Capture Using a Hemi-Labile Iron Complex,” Angew. Chem. Int. Ed.; Aug. 4, 2025; 64; e202505723 (doi.org/10.1002/anie.202505723), including its Supporting Information section, is incorporated herein by reference in its entirety for all purposes.

It should be understood that the subject matter defined in the appended claims is not necessarily limited to the specific implementations described above. The specific implementations described above are disclosed as examples only. While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

When a portion (e.g., a layer, a structure, a region) is “on”, “adjacent”, “above”, “over”, “overlying”, or “supported by” another portion, it can be directly on the portion, or an intervening portion (e.g., layer, structure, region) may also be present. Similarly, when a portion is “below” or “underneath” another portion, it can be directly below the portion, or an intervening portion (e.g., layer, structure, region) may also be present. A portion that is “directly adjacent”, “directly on”, “immediately adjacent”, “in contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of capturing carbon dioxide, comprising:
exposing a redox-active species to carbon dioxide such that the redox-active species captures carbon dioxide,
wherein the redox-active species is capable of capturing more than one molecule of carbon dioxide per electron transferred to the redox-active species.

2. The method of claim 1, wherein more than one molecule of carbon dioxide is captured by the redox-active species per electron transferred to the redox-active species.

3. (canceled)

4. The method of claim 1, wherein the redox-active species comprises a metal complex.

5. The method of claim 1, wherein the redox-active species comprises a ligand with at least one hemi-labile metal coordination site.

6. The method of claim 5, wherein the redox-active species comprises a ligand with multiple hemi-labile metal coordination sites.

7. The method of claim 5, wherein the metal is iron, nickel, cobalt, and/or copper.

8. The method of claim 1, wherein the redox-active species comprises ferric ethylenediamine-di-(o-hydroxyphenylacetate) (Fe-EDDHA).

9. The method of claim 8, wherein the Fe-EDDHA is in an aqueous solution.

10. The method of claim 1, wherein CO₂ reduction is prevented by a guardian that protects a metal of the redox-active species.

11. The method of claim 10, wherein the guardian comprises a nitrogen-containing heterocyclic compound.

12. The method of claim 10, wherein the guardian comprises pyridine-3-carboxylic acid amide (nicotinamide); pyridine-4-carboxamide (isonicotinamide); 4-dimethylaminopyridine (DMAP); 1,8-Diazabicyclo[5.4.0]undec-7-ene (DBU); 3,5-Dimethylisonicotinamide; 1-Methylimidazole; Benzimidazole; 1,3-Bis(2,4,6-trimethylphenyl)-1,3-dihydro-2H-imidazol-2-ylidene (IMes) and/or 2,2′-Bipyridine (bpy).

13. The method of claim 1, wherein the redox-active species electrochemically captures the carbon dioxide.

14. The method of claim 13, wherein the method comprises applying an electrical potential to an electrochemical cell within which the redox-active species is present to capture the carbon dioxide.

15. A carbon-capture system comprising:
an electrochemical cell, and
a redox-active species configured to capture carbon dioxide when an electrical potential is applied to the electrochemical cell,
wherein the redox-active species is capable of capturing more than one molecule of carbon dioxide per electron that is transferred to the redox-active species.

16. (canceled)

17. The carbon-capture system of claim 15, wherein the redox-active species is an organometallic species.

18. The carbon-capture system of claim 15, wherein the redox-active species comprises a ligand with at least one hemi-labile metal coordination site.

19. The carbon-capture system of claim 18, wherein the redox-active species comprises a ligand with multiple hemi-labile metal coordination sites.

20. The carbon-capture system of claim 18, wherein the metal is iron, nickel, cobalt, and/or copper.

21. The carbon-capture system of claim 15, wherein the redox-active species comprises ferric ethylenediamine-di-(o-hydroxyphenylacetate) (Fe-EDDHA).

22-25. (canceled)

26. A carbon-capture process comprising a symmetric cyclic electrochemical system, wherein the system comprises a redox-active organometallic species comprising a ligand with multiple hemi-labile iron coordination sites.

27-31. (canceled)
